(19) United States
(12) Patent Application Publication
(10) Pub. No.: US 2025/0329475 A1
(43) Pub. Date: Oct. 23, 2025

(54) RENEWABLE WALL FOR FUSION REACTORS

(71) Applicant: The Regents of the University of California, Oakland, CA (US)

(72) Inventors: Eric M. Hollmann, La Jolla, CA (US); Jose A. Boedo, San Diego, CA (US); Erick Rolando Martinez Loran, San Diego, CA (US); Alborz Izadi, San Diego, CA (US)

(21) Appl. No.: 18/861,858

(22) PCT Filed: May 11, 2023
(86) PCT No.: PCT/US2023/021935

§ 371 Date: Oct. 30, 2024

Related U.S. Application Data
(60) Provisional application No. 63/364,551, filed on May 11, 2022.

(51) Int. Cl. G21B 1/13; G21B 1/05; G21B 1/25

(52) U.S. Cl. CPC G21B 1/13; G21B 1/05; G21B 1/25

(57) ABSTRACT

A renewable wall of a fusion reactor chamber is disclosed. In some embodiments of the disclosed technology, a fusion reactor device comprises a fusion reactor chamber including an inner wall that is at least partially made of a wall-forming aggregate to be exposed to a heat flux in the fusion reactor chamber during a nuclear fusion reaction which decomposes into constituent pebbles upon this heat flux exposure, a material collection system structured to collect via gravity, from the inner wall of the fusion reactor, a material recovery unit connected to the material collection system to recover the decomposed wall-forming material and provide a recovered wall-forming material to a wall-forming material container, and an array of extrusion channels connected between the inner wall and the wall-forming material container to feed the recovered wall-forming material from the wall-forming material container toward the inner wall of the fusion reactor chamber.

### CROSS-REFERENCE TO RELATED APPLICATION

This patent document claims priority to and benefits of U.S. Provisional Patent Application No. 63/364,551, titled “RENEWABLE WALL FOR FUSION REACTORS” and filed on May 11, 2022. The entire contents of the before-mentioned patent application are incorporated by reference as part of the disclosure of this document.

### STATEMENT REGARDING FEDERALLY SPONSORED RESEARCH OR DEVELOPMENT

This invention was made with government support under DE-AR0001373, awarded by the Department of Energy (DOE). The government has certain rights in the invention.

### TECHNICAL FIELD

The patent document generally relates to a fusion reactor, and more particularly to a fusion reactor wall.

### BACKGROUND

Magnetic fusion reactors are being actively researched worldwide toward development of power plants. The plasma-facing wall material is one of the most critical outstanding issues in the power plant design. Each existing technology, e.g., low-Z solid wall (where Z is the atomic number of the material), high-Z solid wall, and liquid metal wall), has different shortcomings, such as wall melting, tritium absorption, wall erosion, neutron transmutation, and core performance degradation.

### SUMMARY

The disclosed technology can be implemented in some embodiments to provide methods, materials and devices that pertain to a renewable fusion reactor wall consisting of an aggregate/binder combination that crumbles under heat and particle flux.

In some implementations of the disclosed technology, a fusion reactor device may include a fusion reactor chamber including an inner wall that is at least partially made of a wall-forming material to be exposed to a heat flux in the fusion reactor chamber during a nuclear fusion reaction, a material collection system structured to collect, from the inner wall of the fusion reactor, a decomposed wall-forming material decomposed by the heat flux, and a material recovery unit coupled to the material collection tray to recover the decomposed wall-forming material and to provide a recovered wall-forming material to a wall-forming material container, and an array of extrusion channels coupled between the inner wall and the wall-forming material container to feed the recovered wall-forming material from the wall-forming material container toward the inner wall of the fusion reactor chamber.

In some implementations, a method for wall-forming material recovery may include collecting, from an inner wall of a fusion reactor chamber, a decomposed wall-forming material decomposed by a heat flux in the fusion reactor chamber during a nuclear fusion reaction, generating a recovered wall-forming material from the decomposed wall-forming material, and providing the recovered wall-forming material to the inner wall of the fusion reactor chamber.

In some implementations of the disclosed technology, a device for renewing an inner wall of a fusion reactor chamber includes an array of extrusion channels structured to feed a wall-forming material toward the inner wall of the fusion reactor chamber, a material collection tray structured to collect a decomposed wall-forming material from the inner wall of the fusion reactor, and a material recovery unit structured to recover the decomposed wall-forming material back to the wall-forming material.

In some implementations of the disclosed technology, the wall-forming material includes graphite pebbles mixed with a binder material. In some implementations of the disclosed technology, a wide range of solid pebble materials, such as boron, glassy carbon, boron nitride, beryllium and tungsten, may be implemented.

In some implementations of the disclosed technology, the binder material is baked out on the way to a hot inner wall of the fusion reactor chamber to glue the pebbles together.

In some implementations of the disclosed technology, the extrusion channels are structured to extrude pebble rods generated from the pebbles and the binder material into the fusion reactor chamber.

In some implementations of the disclosed technology, the material collection system collects pebbles decomposed from the pebble rods.

In some implementations of the disclosed technology, the material recovery unit recovers the collected pebbles as well as tritium absorbed by the pebbles.

The above and other aspects and implementations of the disclosed technology are described in more detail in the drawings, the description, and the claims.

### BRIEF DESCRIPTION OF THE DRAWINGS

FIG. 1 shows an example of a device for renewing an inner wall of a fusion reactor chamber based on some implementations of the disclosed technology.

FIG. 2A shows a side view of a single divertor module for renewing an inner wall of a fusion reactor chamber based on some implementations of the disclosed technology. FIG. 2B shows a front view of a single divertor module for renewing an inner wall of a fusion reactor chamber based on some implementations of the disclosed technology. FIG. 2C illustrates an example alternate side view divertor module geometry, although in both cases gravity is used to recover the pebbles.

FIG. 3A shows an example baking test stand based on some embodiments of the disclosed technology. FIG. 3B shows BN spheres. FIG. 3C shows an example of a baked out carbon sphere conglomerate rod based on some embodiments of the disclosed technology.

FIG. 4A shows a photograph of an example of an extrusion test stand based on some embodiments of the disclosed technology. FIG. 4B shows a graphical schematic of the same example of an extrusion stand based on some embodiments of the disclosed technology.

FIG. 5A shows an example of a laser test stand based on some embodiments of the disclosed technology. FIG. 5B shows an example of a sample holder based on some embodiments of the disclosed technology. FIG. 5C shows an example IR signal from a sample.

FIG. 5D shows a top view of an optical breadboard based on some embodiments of the disclosed technology.

FIG. 6 shows an example of a stress gauge used for testing mechanical properties of pebble rods in some embodiments of the disclosed technology.

FIG. 7 shows an example of a 2D aggregate simulation method based on some embodiments of the disclosed technology.

FIG. 8A shows an example of glued contact model based on some embodiments of the disclosed technology. FIG. 8B shows an example of the same contact model, but using SiC ceramic spheres added to graphite, rather than BN added to graphite as in FIG. 8A.

FIGS. 9A-9B show methods for removing particles when the particles break off in the 2D simulations.

FIG. 10A shows an example tokamak, and FIG. 10B shows wall melting in JET tokamak.

FIGS. 11A and 11B show schematics of experimental setups showing extruding stand and laser stand.

FIGS. 12A-12C show friction force and outgassing rates in the extrusion system.

FIGS. 13A-13C show typical effect of the incident Gaussian beam on a pebble rod, illustrating (13B) front surface aggregate recession and (13C) pebble recovery.

FIGS. 14A-14B show measurements of sample surface temperature including cross-checks between thermocouple and IR thermography diagnostics.

FIG. 15 shows estimation of sample outgassing under laser heat load.

FIGS. 16A-16C show pebble ejection velocity from NIR thermography imaging.

FIGS. 17A-17D show behavior of pebble samples at different front-surface heat loads including front surface recession (erosion) rate, ejected pebble velocity, front surface outgassing rate, and front surface sublimation rate.

FIG. 18A shows 3D simulation of the low-power laser heating test to obtain thermal properties of the sample. FIG. 18B shows comparison of experimental thermocouple temperature histories with MOOSE-simulated values.

FIG. 19A shows a 3D MOOSE simulation of the 3-point beam bending test of a pebble rod sample. FIG. 19B shows comparison of load-displacement response from experiments and simulation in MOOSE.

FIG. 20A shows 2D simulation of the response of the pebble rod to laser heating. FIG. 20B shows average temperature of the exposed front surface. FIG. 20C shows simulated temporal rate of front-surface recession.

FIGS. 21A-21B show estimated power balance of specimen subject to laser heating for graphite reference sample and pebble-based sample, including data on laser input power, conducted power loss, sublimation power loss, radiated power loss, and power loss due to ejection of heated pebbles (recession power loss).

FIGS. 22A-22B show parameter scans to change front-surface recession rate by varying pebble size and varying binder fraction.

FIGS. 23A-23B show international thermonuclear experimental reactor (ITER) simulations to illustrate that most heat loads and tritium retention will occur in the lower divertor region.

FIG. 24 shows an illustration of forces on pebbles falling into plasma.

FIGS. 25A-25C show an example of intact pebble recovery.

FIGS. 26A-26B show an example of 2D simulation of agglomerate recession under high heat loads.

FIGS. 27A-27B show an example of 3D simulation of agglomerate recession under high heat loads.

FIGS. 28A-28C show tuneability of pebble recession achieved by tuning binder (matrix) fraction, pebble size, and pebble composition.

FIG. 29 shows an example of bake-out in an extrusion stand.

FIG. 30 shows an example of low ejected pebble velocity.

FIG. 31 shows an example of low extrusion friction force in an extrusion stand.

FIG. 32 shows an example method for wall-forming material recovery based on some embodiments of the disclosed technology.

### DETAILED DESCRIPTION

Section headings are used in the present document only for ease of understanding and do not limit scope of the embodiments to the section in which they are described.

The disclosed technology can be implemented in some embodiments to provide a novel technique for creating stable reactor walls for future nuclear fusion reactors, such as tokamak reactors. The disclosed technology can be implemented in some embodiments to ensure a sustainable, continuous operation of nuclear fusion reactors by creating stable, continuously renewable reactor walls capable of handling high-energy plasma.

Fusion reactors produce large amounts of power in a small volume, meaning that the amount of power per unit area is very large, of the order of 40-100 MW/m² and there is no engineering solution for a commercial fusion reactor wall that can take that much power.

The disclosed technology can be implemented in some embodiments to provide a renewable wall that can be continuously produced as it is being destroyed by the high heat flux, thereby offering a solution to the power flux problem.

The disclosed technology can be implemented in some embodiments to renew the wall that is being destroyed by the high heat flux form the fusion process. As the wall crumbles, heat is removed at a much higher rate than conventional cooling methods, and tritium, which is an extremely expensive fuel that is required for fueling the reactor and cannot be lost into the vessel walls, is removed as it accumulates. In some implementations, the crumbling material can be reused again. In addition, the low Z version of this material (carbon, boron, etc.) features very low neutron activation, if any. It is anticipated that the pebble materials will be low atomic number (such as carbon, boron, or boron nitride) since these give best core performance. However, it may be that medium atomic number (such as aluminum nitride or silicon carbide) or higher atomic number (such as tungsten) pebbles may work better in some reactor designs

In some implementations, walls that are made of solid tungsten or tungsten alloy cannot take the expected fusion output power, so they will melt. When the tungsten walls melt, high amounts of impurities are injected in the plasma, reducing the fusion performance. Neutron flux damages the tungsten and creates blisters, and tritium can accumulate.

In some embodiments of the disclosed technology, the wall material is delivered to the reactor wall using a thick, semi-fluid slurry that, when exposed to heat, becomes a solid aggregate (in the form of rods, slats, etc.) that serves as a sacrificial wall material. In some embodiments of the disclosed technology, the aggregate may include carbon, boron, silicon carbide, berylium, tungsten or boron nitride pellets mixed with carbon fillers and solvent and thus is able to take the large heat flux from fusion reactors. The aggregate, once solidified and exposed to the reactor plasma, is designed to crumble when heated to high temperatures (≈2000° C.) expected in fusion reactors. In some embodiments of the disclosed technology, the aggregate can be tuned to crumble at various temperatures, and when the aggregate crumbles, it takes with it heat and tritium, solving two of the main problems in the fusion engineering. The aggregate components can be recycled and mixed again so it is fully recyclable. The pumped slurry delivery technique is one possible method of delivering aggregate solid material to the reactor wall but is not the only possibility; pebble rods, slats, etc. can also be formed far from the reactor and delivered as solid objects.

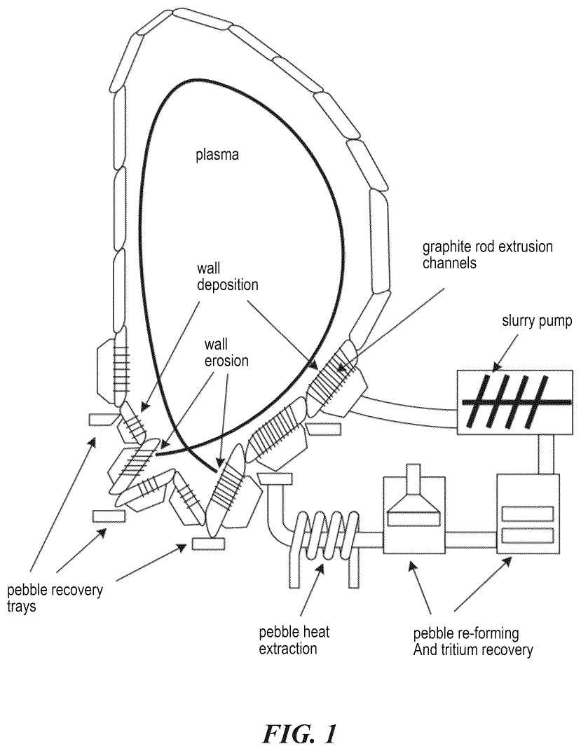

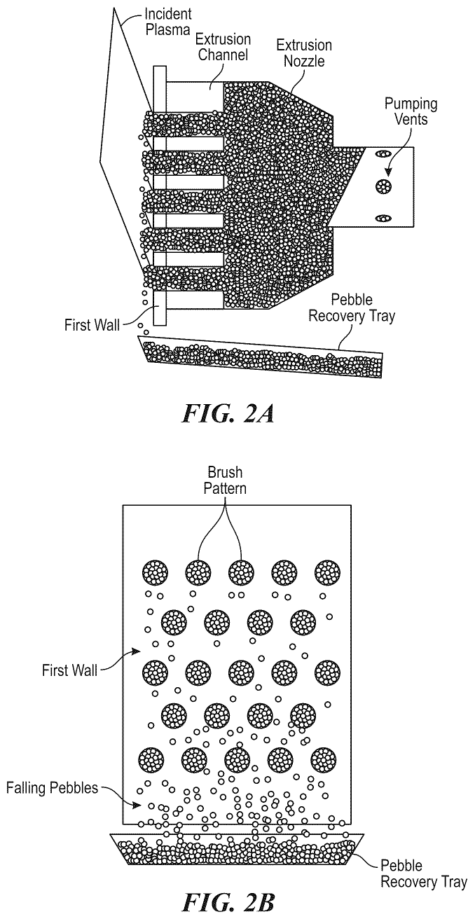

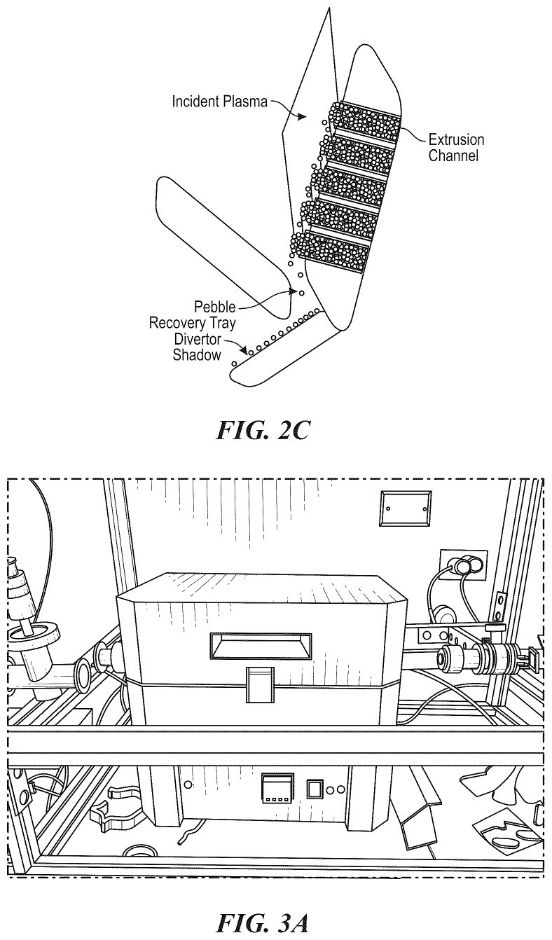

FIG. 1 shows an example of a single divertor module for renewing an inner wall of a fusion reactor chamber based on some implementations of the disclosed technology. FIG. 2A shows a side view of a device for renewing an inner wall of a fusion reactor chamber based on some implementations of the disclosed technology. FIG. 2B shows a front view of the single divertor module for renewing an inner wall of a fusion reactor chamber based on some implementations of the disclosed technology. FIG. 2C illustrates an example alternate side view divertor module geometry, although in both cases gravity is used to recover the pebbles.

Referring to FIG. 1, in some implementations of the disclosed technology, a device for renewing an inner wall of a fusion reactor chamber includes an array of pebble rod extrusion channels, one or more pebble recovery trays, a pebble heat extraction unit, a pebble reforming and tritium recovery unit, and a slurry pump.

In some implementations of the disclosed technology, a device for renewing an inner wall of a fusion reactor chamber includes an array of extrusion channels arranged along a first wall and extending from an extrusion nozzle. In addition, the device further includes a pebble recovery system disposed under the array of extrusion channels and structured to collect pebbles falling from the extrusion channels arranged along the first wall.

In some implementations of the disclosed technology, a device for renewing an inner wall of a fusion reactor chamber includes an array of extrusion channels structured to feed a wall-forming material toward the inner wall of the fusion reactor chamber, a material collection system structured to collect a decomposed wall-forming material from the inner wall of the fusion reactor, and a material recovery unit structured to recover the decomposed wall-forming material back to the wall-forming material.

Referring to FIG. 1, in some embodiments of the disclosed technology, a continuously replenishing low-Z wall may solves many challenges associated with fusion reactor wall, by performing the following operations: Graphite initially exists in the form of slurry of pebbles mixed with binder. Binders are baked out on their way to hot walls gluing pebbles together. Graphite rods are extruded through channels into a vacuum chamber. Rods decompose into pebbles which are recovered by gravity. Pebbles are processed to reform and recover tritium soaked up by graphite pebbles.

Referring to FIGS. 2A-2C, in some embodiments of the disclosed technology, graphite rods are arranged in a pattern to protect a fusion reactor wall from plasma heat flux. In some implementations, graphite rods may include round rods arranged in a hex pattern. In other implementations, different patterns are possible.

The slurry design implemented based on some embodiments can avoid binding/galling in channels while outgassing into vacuum chamber.

The disclosed technology can be implemented in some embodiments to provide tunability of disintegration (10× different heat loads on inner vs. outer leg of divertor).

The disclosed technology can be implemented in some embodiments to address the following issues: (1) slurry extrusion (friction, outgassing); (2) front surface disintegration (tunability for deposition and erosion regions); and (3) scalability to neutron environment

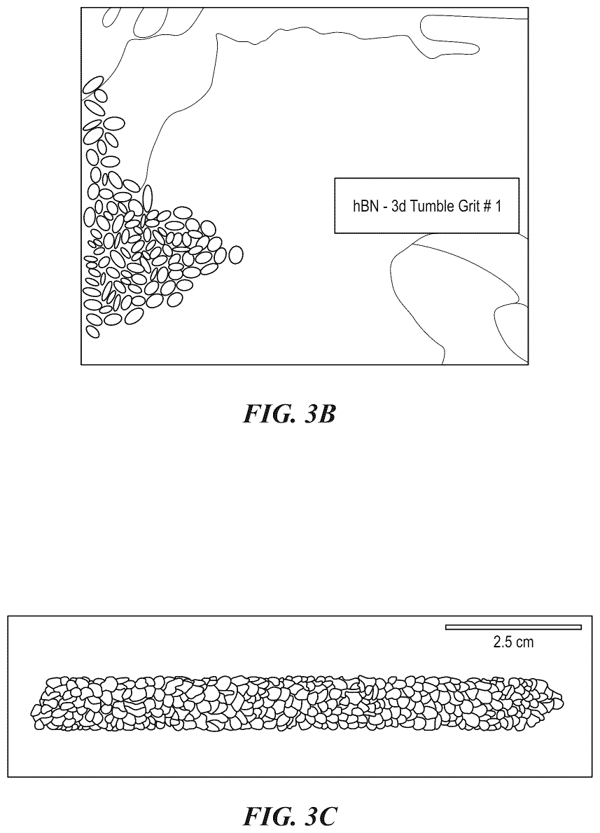

FIG. 3A shows an example baking test stand based on some embodiments of the disclosed technology. FIG. 3B shows BN spheres. FIG. 3C shows an example of a baked out carbon sphere conglomerate rod based on some embodiments of the disclosed technology.

In some embodiments of the disclosed technology, a slurry baking test using amorphous carbon, glassy carbon, and BN spheres (e.g., BN spheres produced in gem tumbler) can be performed by producing about 1 cm wide cylindrical conglomerate samples baked out at 500-800° C.

In some implementations, different hydrocarbon liquid binders, such as polyvinyl acetate, phenolic resin, isopropyl alcohol, butyl benzene, glycerol, can be used. In one example, phenolic resin dissolved in acetone can be used as a binder. In one example, the binders may be used to bind to amorphous carbon. In another example, the binders may be used to bind to glassy carbon.

In some implementations, a tunability of mechanical strength can be achieved by changing phenolic/butyl and amorphous/glassy carbon ratios.

In some implementations, adding in BN may create more fragile/easily disintegrated samples.

In some implementations, the baking of slurry into conglomerate may be performed within SS tube walls.

In some implementations, the binding is caused at early stages of baking process, and can be prevented by pre-baking to 200 C in Teflon tube.

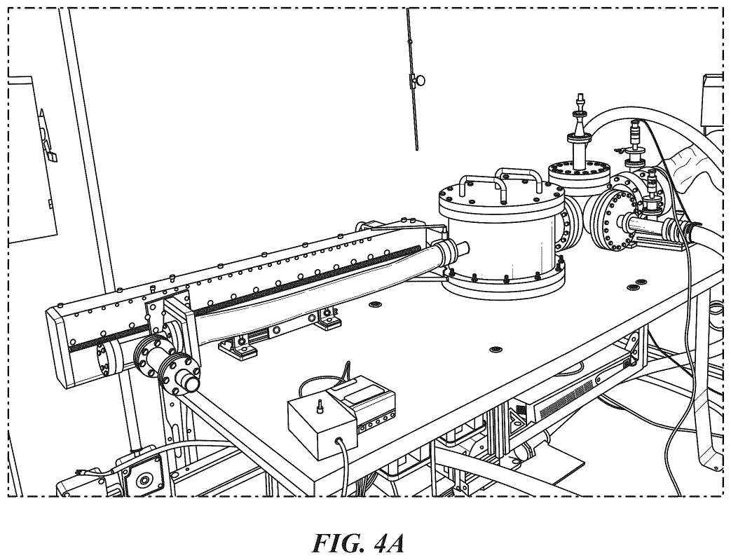

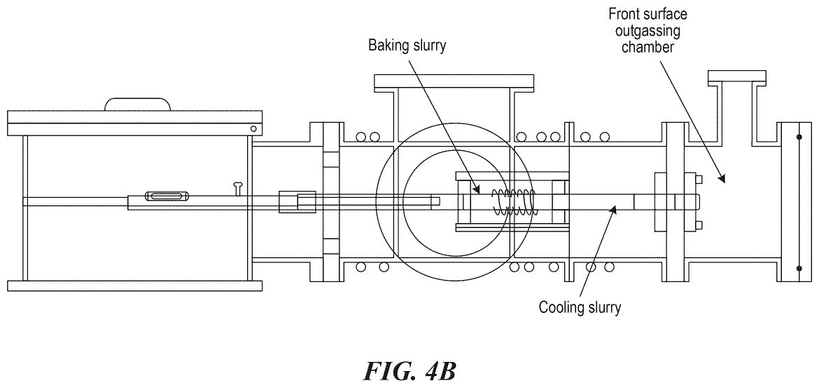

FIG. 4A shows a photograph of an example of an extrusion test stand based on some embodiments of the disclosed technology. FIG. 4B shows a graphical schematic of the same example of an extrusion stand based on some embodiments of the disclosed technology.

In some implementations, an extrusion stand may include a linear translator and load cell.

In some implementations, an extrusion stand may include a guide tube, vacuum chamber, and heating coil to measure outgassing and friction force of slurry during baking.

In some implementations, an extrusion stand may hook up thermocouple vacuum feedthroughs for temperature measurement.

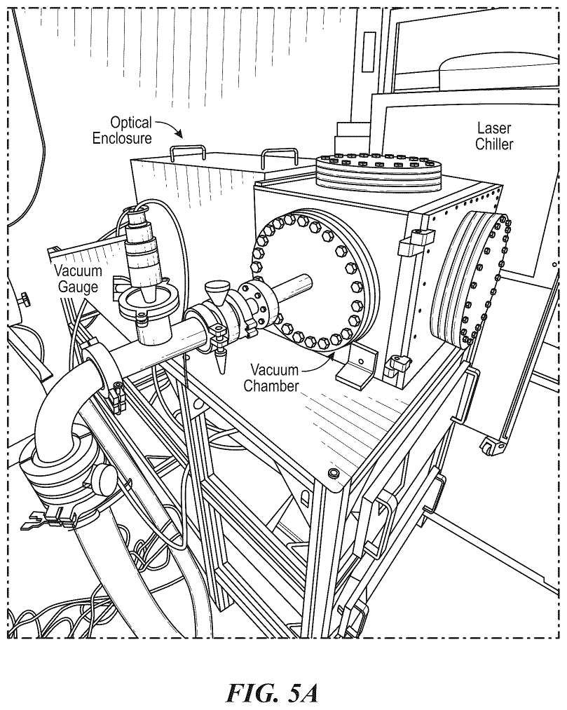

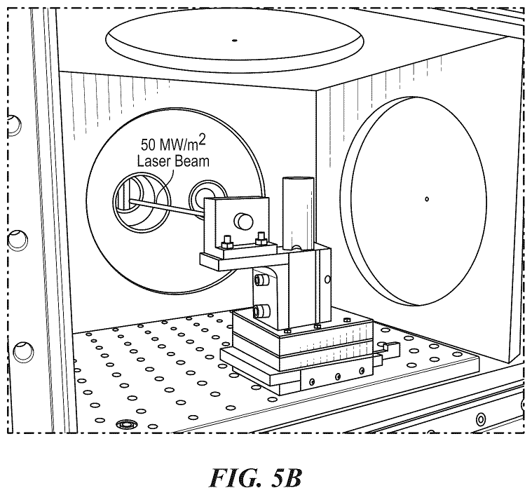

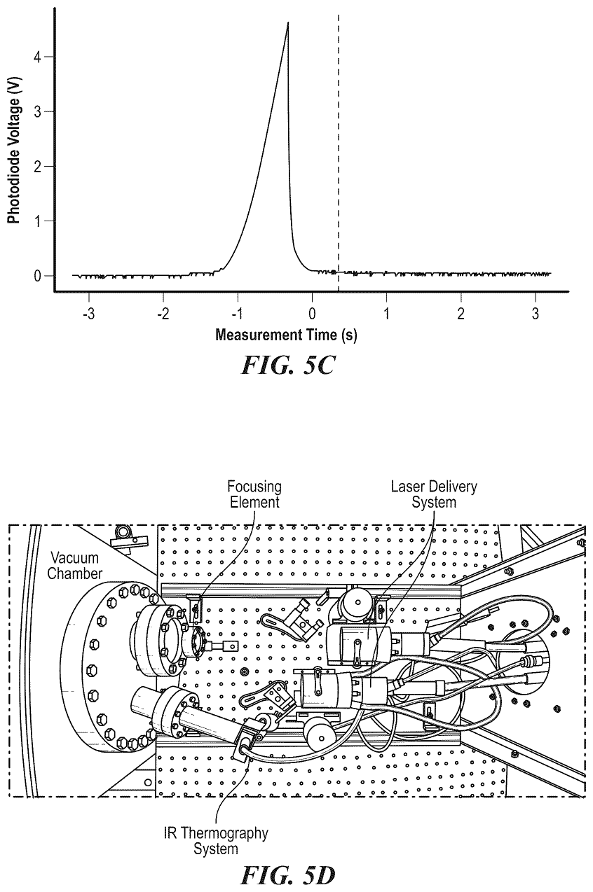

FIG. 5A shows an example of a laser test stand based on some embodiments of the disclosed technology. FIG. 5B shows an example of a sample holder based on some embodiments of the disclosed technology. FIG. 5C shows an example IR signal from a sample. FIG. 5D shows a top view of an optical breadboard based on some embodiments of the disclosed technology.

In some implementations, the laser test stand may use two 3 kW lasers to reach 50 MW/m² steady state front-surface heat loads on 1 cm². Vacuum chamber allows heating tests to be done under vacuum or inert atmospheres. Both alignment lasers and high power lasers are operational.

In some implementations, a lens allows focusing to adjust heat flux on target. In some implementations, only diagnostics are IR photodiode and mass loss. In some implementations, the laser test stand may further include thermocouples and a small IR imager.

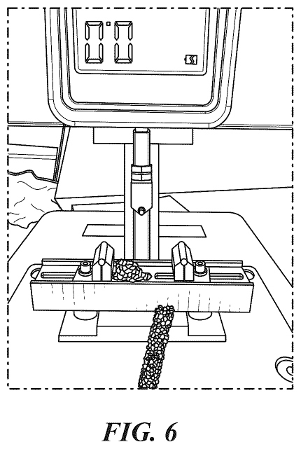

FIG. 6 shows an example of a stress gauge used for testing mechanical properties of pebble rods in some embodiments of the disclosed technology.

In some embodiments of the disclosed technology, a conglomerate stress testing process can be performed on baked-out conglomerate samples. In one example, stress (break force) tests are performed on baked-out conglomerate samples. In one example, a physical method can be used to characterize binder strength. The disclosed technology can be implemented in some embodiments to interface with numerical models to improve accuracy. Table 1 gives examples of measured binder strengths; this list of binders is not exclusive, but rather illustrates some examples measurements of binder breaking strength.

TABLE 1
Sample break force data for different conglomerates

| | | Particle | | Specimen | | | Flexural |
|---|---|---|---|---|---|---|---|
| | Particle | Diameter | Specimen | Diameter | Break | Flexural | Strength |
| | Diameter | Stdev | Diameter | stdev | Force | Strength | Stdev |
| Sample | (mm) | (mm) | (mm) | (mm) | (N) | (Pa) | (Pa) |
| Matrix | 2.2 | 0.3 | 9.5 | 0.3 | 0.7 | 8.3E4 | 5.1E3 |
| Carbon/Butyl- | | | | | | | |
| benzene #1 | | | | | | | |
| Matrix | 2.2 | 0.3 | 9.4 | 0.3 | 0.3 | 3.6E4 | 2.1E3 |
| Carbon/ | | | | | | | |
| Acetone #22 | | | | | | | |
| hBN-coated | 1.0 | 0.1 | 9.4 | 0.2 | 3.2 | 3.9E5 | 2.1E4 |
| GC/Acetone | | | | | | | |
| (#31) | | | | | | | |

The disclosed technology can be implemented in some embodiments to provide a predictive tool that can be used to extrapolate from experimental observations in laboratory to reactor environment.

The disclosed technology can be implemented in some embodiments to provide 2D capability to simulate surface heating with welding laser. The disclosed technology can be implemented in some embodiments to use 2D model for initial parameter study. The disclosed technology can be implemented in some embodiments to refine models for physical behavior (conglomerate break-up, heat transfer, etc.) using 2D models. The disclosed technology can be implemented in some embodiments to extend modeling to 3D. The disclosed technology can be implemented in some embodiments to apply model to neutron heating (volumetric heat source).

The disclosed technology can be implemented in some embodiments to provide 2D capability for surface heating. The disclosed technology can be implemented in some embodiments to perform a basic parameter study with 2D model. The disclosed technology can be implemented in some embodiments to provide a framework for simulating particle removal with appropriate moving boundary condition due to break-up.

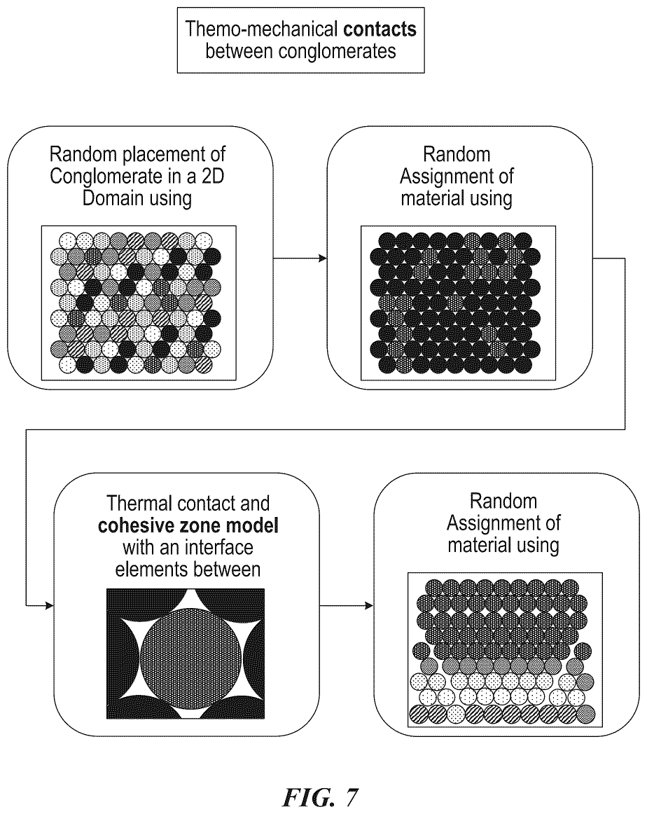

FIG. 7 shows an example of a 2D aggregate simulation method based on some embodiments of the disclosed technology.

Referring to FIG. 7, spheres are discretized as randomly-placed bodies.

In some implementations, the spheres are in thermal contact with each other to transfer heat between the spheres. In one example, epoxy between spheres can be represented by a gap conductance of 0.13 W/(m²-K).

The disclosed technology can be implemented in some embodiments to provide two approaches for mechanical interaction between spheres, both with perfect bond up to tensile strength (currently 1 MPa): (1) glued contact model allows for interactions between non-matching meshes; and (2) cohesive zone model represents loss of strength on common meshed interface.

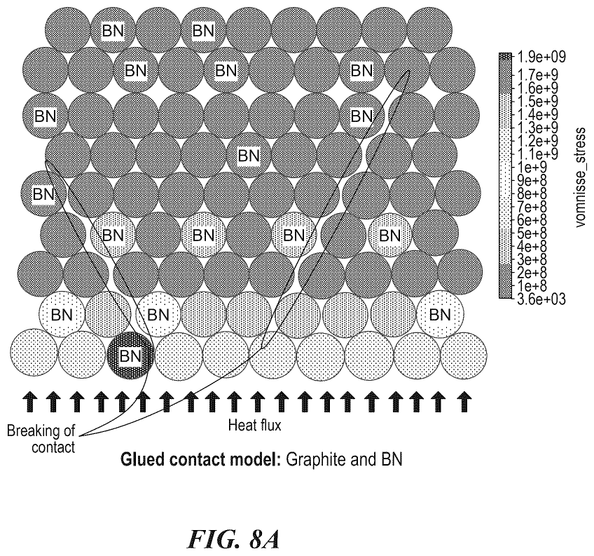

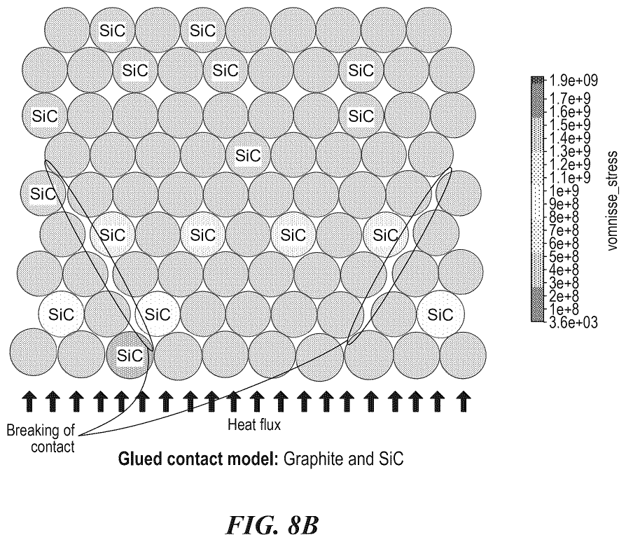

FIG. 8A shows an example of glued contact model based on some embodiments of the disclosed technology. FIG. 8B shows an example of the same contact model, but using SiC ceramic spheres added to graphite, rather than BN added to graphite as in FIG. 8A.

2D front-surface heating simulations can be performed with varying materials. In some implementations, graphite intermixed with BN or SiC spheres are simulated in 2D. As shown in FIGS. 8A and 8B, contact breaking tends to occur along straight fault lines.

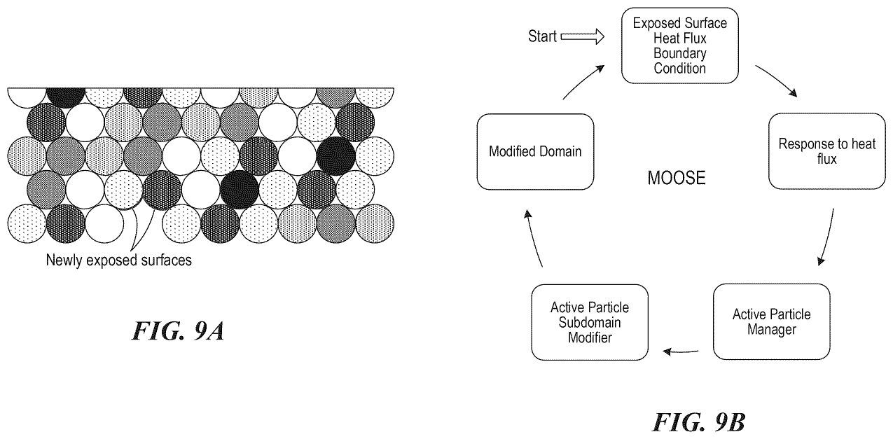

FIGS. 9A-9B show methods for removing particles when the particles break off in the 2D simulations. In one example, the method may remove separated particles from the model. In another example, the method may expose a new surface to the heat flux. The disclosed technology can also be implemented in some embodiments to identify separated particles.

The disclosed technology can also be implemented in some embodiments to provide technical improvements over existing state of the art, including: (1) increased max heat flux (40 MW/m² vs. 20 MW/m² for W mono-block); increased transmutation lifetime (>10 yrs. vs. 3 yrs. for W mono-block); increased T inventory lifetime (≈10 yrs. vs. 2 yrs. for W mono-block); and reduced first wall activation (compared with high-Z concepts).

The disclosed technology can also be implemented in some embodiments to provide a renewable low-Z wall for fusion reactors with built-in tritium recovery.

As shown in FIGS. 1 and 2A-2B, the disclosed technology can also be implemented provide a slurry-based renewable low-Z wall for fusion reactors and a method for tritium recovery, combined with resilience against high heat loads and sputtering.

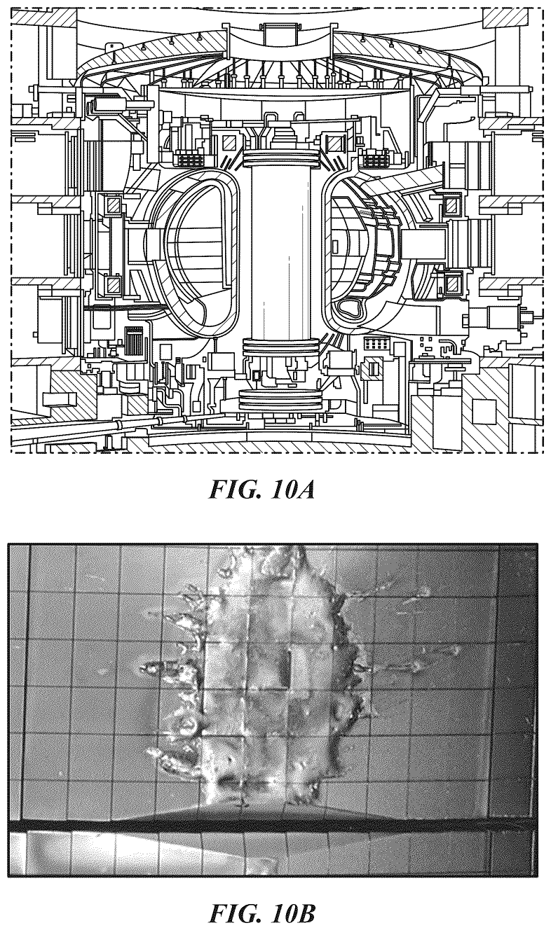

FIG. 10A shows an example tokamak, and FIG. 10B shows wall melting in JET tokamak.

Magnetic fusion reactors being actively researched worldwide toward development of power plants. The plasma-facing wall material is one of the most critical outstanding issues in the power plant design. Each existing technology (e.g., low-Z solid wall, high-Z solid wall, and liquid metal wall) has different shortcomings, such as wall melting, tritium absorption, wall erosion, neutron transmutation, or core performance degradation.

The disclosed technology can be implemented in some embodiments to provide a low-Z slurry-based renewable wall having better features than the existing technology (e.g., no wall melting, low tritium absorption, high erosion resistance, low neutron sensitivity, low core degradation).

The disclosed technology can be implemented in some embodiments to address multiple challenges in slurry design: tunable front-surface disintegration to allow use in both erosion and deposition regions of the wall; optimization of slurry heating and delivery to reduce front-surface outgassing to tolerable levels; extrapolation to neutron-heating environment using simulations.

The disclosed technology can be implemented in some embodiments to provide pebble-based extruded carbon rods for extreme plasma heat flux environments.

The disclosed technology can be implemented in some embodiments to provide continuously renewable (extrudable) pebble-based carbon rods for use as plasma-facing components in extreme steady-state plasma flux environments. The disclosed technology can be implemented in some embodiments to provide a first wall that can survive long-term in future magnetic fusion power reactors while also improving recovery of the reactor fuel (tritium and deuterium atoms). Bench tests applying extreme steady-state front-surface heat loads of up to 50 MW/m² are presented. Continuous pebble rod front-surface surface recession and intact pebble recovery are successfully demonstrated, at a rate of order 0.2 cm/s. Numerical simulations of the pebble rod front-surface recession are able to match observations reasonably well, indicating that the recession mechanism can be understood as occurring due to pebble thermal expansion and resulting shock and cracking of the inter-pebble binder. Tests of the pebble rod extrusion demonstrate that friction between the rods and the stainless steel extrusion channel is tolerably low (<50 N for the expected channel length) over a wide range of temperatures. Front surface outgassing rates below 1000 Torr-L/s/m² are achieved, believed to be sufficiently low for use in magnetic fusion reactors. Initial parametric scans over pebble rod size and binder fraction to vary front-surface recession rates are presented.

A significant hurdle slowing commercial development of magnetic fusion energy (MFE) power reactors is the development of plasma-facing components (PFCs), which provide long-term protection from plasma erosion, heating, and neutron damage while avoiding fusion fuel (tritium) accumulation and allowing good core performance. Low-Z materials, such as carbon, beryllium, and boron, are often preferred in present non-burning MFE experiments, like the DIII-D tokamak, because they are poor radiators at tokamak or stellarator core (multi-keV) temperatures, giving good core performance. However, low-Z wall materials erode rapidly (>10 cm/year in a reactor) and retain tritium in deep (>10 μm) co-deposits at unacceptably high levels. High-Z walls (such as Inconel-718, RAFM steels such as Eurofer97, V-15Cr-5Ti alloys, or tungsten) are favored in studies for future magnetic fusion reactors, like DEMO, since these high-Z metals have lower erosion (of order 1 cm/year in a reactor) and high melting temperature. However, the use of high-Z metals as a PFC brings additional problems, including melting during transients, cracking, reduced core performance due to line radiation, transmutation and embrittlement due to neutrons, and increasing tritium retention due to displacement damage and helium blister formation. Mixed materials have been proposed, but these can change stoichiometry during plasma exposure, resulting in inferior properties. Flowing liquid metal walls are being investigated and have many attractive features, such as complete resistance to neutron damage, but have been extremely challenging to implement in practice, due to their susceptibility to splashing and magnetohydrodynamic (MHD) events, high vapor pressure, high reactivity, and difficulty of controlling the return flow. Real-time low-Z wall conditioning/replenishment has also been proposed, for example, by spraying or dropping boron powder, but this technique lacks an extraction mechanism for the accumulating low-Z powder and slag in the reactor vacuum vessel. High-Z metal protected by capillary tubes wicking low-Z molten metal has also been proposed but also lacks an extraction technique for the resulting low-Z vapor and slag. As discussed above, first wall solutions based on some embodiments of the disclosed technology use fixed solid walls. Fixed solid walls are also proposed for ITER, but this approach may not scale well to MFE reactors. In other embodiments of the disclosed technology, liquid metal walls can be used.

Due to their excellent core performance, low-Z walls would be attractive as MFE reactor first-wall materials if the associated problems could be solved. We propose a sacrificial low-Z wall made of a pebble-binder slurry that is extruded into the divertor region and breaks down into constituent pebbles continuously. The detached pebbles are carried away from the main chamber where they outgas tritium, helium, and hydrocarbons. Outgassed pebbles can be reconditioned into a slurry and re-extruded to the reactor wall in a closed loop. In an MFE reactor, this concept could help mitigate the main outstanding disadvantages of low-Z walls, such as high erosion rates and tritium co-deposition.

Referring to FIG. 1, slurry-based plasma-facing component based on some embodiments may include a fusion reactor with a tritium recovery loop. FIG. 2C illustrates an example of plasma-facing wall section showing extrusion channels and pebble recovery.

A basic possible layout of the ultimately envisioned renewable wall concept is shown in FIG. 1. The pebble rods initially consist of a mixture of low-Z pebbles and a volatile liquid binder. This slurry is pumped toward the first wall in warm pumping channels. As the slurry warms, it dries into solid pebble rods, which are extruded out through channels, shown in FIG. 2C, while the volatile gas from the binder is pumped away. The solidified pebble rods become plasma-facing surfaces. Upon plasma exposure, the pebble rods experience strong thermal gradients and thermal shock, causing the rods to decompose into constituent pebbles. The heated pebbles fall along the first wall and are gathered below the divertor, quickly carrying away heat and tritium. This concept cannot provide full first wall coverage. However, global coverage is not required to achieve the expected benefits of increased power handling, erosion resistance, and tritium recovery. For example, in the lower single null ITER geometry shown in FIG. 1, simulations indicate that the greatest heat loads, erosion, and tritium deposition will all occur in the lower divertor region (with the greatest heat loads and erosion in the outer leg, and greatest tritium deposition in the inner leg).

Moving from ITER to an MFE reactor, tritium deposition can be expected to shift away from the inner divertor leg toward shadowed divertor regions and pumping ducts. Hydrogenic deposition in shadowed regions of the divertor has been studied extensively in support of the carbon-wall ITER design. MFE reactor first walls are expected to operate at higher temperatures in excess of 600° C., as described in ARIES, ARC, and DEMO reports. At such high temperatures, it has been observed that carbon and hydrocarbon deposition are reduced significantly. In an MFE reactor with hot walls and colder extruded low-Z pebble rods in the divertor, tritium deposition can therefore be expected to shift to the rods themselves or to colder downstream regions like pumping ducts. Periodically heating pumping ducts to temperatures >800° C. could mitigate tritium co-deposits there. Alternatively, co-deposits could be removed from the pumping ducts by flowing oxygen or ammonia through these sections.

Some of the main technical challenges that need to be addressed to allow implementation of the low-Z pebble rod concept to future MFE reactors include outgassing, friction, and front-surface recession rate.

Outgassing is primarily a concern if a “closed-loop” system is implemented without isolation valves between the baking slurry and the plasma; this approach may be desirable to reduce cost and complexity. A multi-stage, “open-loop” system (with gate valves and isolated bake-out sections) would significantly reduce outgassing to the plasma but may also add cost and complexity. In a closed-loop system, the outgassing into the plasma through the extrusion channels from the drying binder must be sufficiently low to avoid perturbing the core plasma and reducing performance. The disclosed technology can be implemented in some embodiments to use 1000 Torr-L/s/m² as an approximate upper bound on allowable outgassing, as will be discussed further below. In either closed-loop or open-loop cases, the hardened slurry needs to be designed to decompose into constituent pebbles upon experiencing plasma heat loads. Tuning this front-surface recession rate is challenging because of the quite different heat loads expected across the divertor regions, for example, of order 1 MW/m² just inside the ITER inner divertor leg strike point in the area of peak deposition, and of order 10 MW/m² on the strike point of the ITER outer divertor leg. At least two different slurry compositions may therefore be required: one tuned for erosion (high heat flux, high erosion) regions and one tuned for deposition (low heat flux, low erosion) regions.

The disclosed technology can be implemented in some embodiments to provide various components of a continuously renewable plasma-facing wall based on carbon pebbles. The carbon pebbles are used together with a binder consisting of a mixture of various volatile hydrocarbons. Friction between the slurry and stainless steel extrusion channels is found to be tolerably low. Also, front-surface outgassing during slurry baking is found to be tolerably low. Front-surface heating tests at (outer divertor leg) fusion reactor-relevant heat loads (up to 50 MW/m²) were conducted. The outgassing during front-surface heating was marginally tolerable, often reaching the upper desired limit of 1000 Torr-L/s/m². Pebble erosion rates of up to 0.5 cm/s were achieved, with typical measured rates averaging about 0.2 cm/s; these are slightly (≈2×) lower than the 0.5 cm/s estimated to be required for handling typical expected outer leg reactor heat loads (≈40 MW/m²).

### Experimental Setup

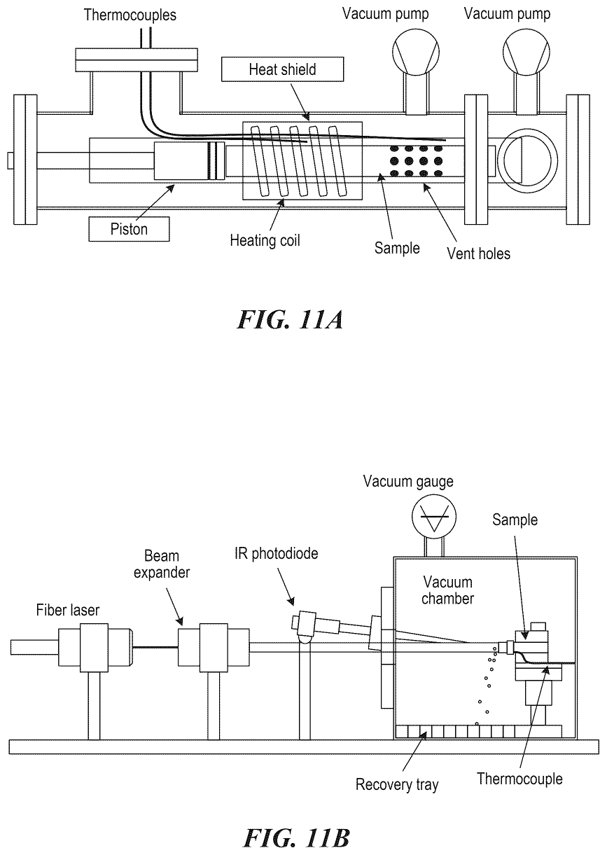

FIGS. 11A and 11B show schematics of experimental setups showing (FIG. 11A) extruding stand and (FIG. 11B) laser stand.

The experimental work may be performed on two laboratory stands: as shown in FIG. 11A, an extrusion system used for baking and extruding slurry, and as shown in FIG. 11B, a laser stand used to study the response of the dried slurry to large front-surface heat loads. In other implementations, a small tube furnace (not shown) equipped with a roughing pump may be used for the preliminary evaluation of bake-out properties of different slurries prior to extrusion stand testing.

The slurries based on some embodiments of the disclosed technology can include small (≈1 mm) carbon pebbles (≈80 to 90 mass percent) mixed with a volatile liquid hydrocarbon mixture (≈ 20 to 10 mass percent) consisting of an alcohol/ketone solvent, a graphite/boron nitride powder filler, and a binder (which could be an -amine or -epoxy-based organic compound). The volatile liquid is expected to be removed during extrusion in channels far from the plasma, resulting in a front-surface outgassing sufficiently low (<20 Torr-L/s/m²) for use in a fusion environment. The trace filler was added to assist pebble binding. To avoid confusion, the data in some embodiments is dominantly for a single fixed typical slurry composition.

The extruding system shown in FIG. 11A consists of a two-stage pumping setup: a bake-out chamber and an end section. The slurry is pumped through the stainless steel extruding tube (Φ=1.55 cm) into the bake-out chamber using a piston driven by a motorized linear translator. An insulated nickel-chrome alloy coil energized by a 1.6 kW DC power supply is used to heat the slurry in the bake-out section. A metal heat shield wrapped around the heating coil reduces thermal dissipation by radiation. Baked samples are recovered at the end section after being extruded. Separate pumping systems and vacuum gauges allow independent monitoring of the outgassing rates in each stage of the system.

The laser stand is shown in FIG. 11B. A ytterbium fiber laser with a wavelength of 1070 nm was used as a heat source. To reduce the power density at the center of the output Gaussian beam, a beam expander of 1.5× was placed in the optical path between the laser source and the sample. The laser was delivered into the chamber through a high-purity fused silica viewport. A gridded recovery tray was used to catch ejected pebbles and estimate pebble velocity from the spatial distribution of the captured pebbles. A second glass (NBK-7) viewport placed at an angle of 18° from the laser beam path is used to make thermography measurements on the sample.

### Extrusion System

To study the friction between the slurry and the extruding channel, the force is monitored on a 30 kg load cell installed at the left end of the piston shaft shown in FIG. 11A. Three different speeds: 0.11 cm/s, 0.57 cm/s and 1.1 cm/s were studied, which are in the range of targeted front-surface recession rates. The specific magnitudes of the extrusion speeds vary depending on the coverage region in the reactor. Estimates come from the power balance between the maximum expected steady-state power plant divertor leg of 40 MW/m² and the heat carried away by the pebbles, giving an extrusion speed of order 0.5 cm/s. A rough upper bound would be 1 cm/s, although, away from the peak heat flux region, lower extrusion speeds will probably be tolerable. Experiments are conducted at 350° C., 715° C. and 900° C. (within the range of expected dry-out temperatures). Temperature control was implemented on the heating section using a simple software PID feedback between the DC power supply and a type-K thermocouple installed in the heating section of the tube. A second type-K thermocouple installed at the end section of the extruding tube was used to monitor the temperature gradient at the exit of the system. The measurements are performed under vacuum, and the system is initially pumped down to a base pressure of ≈20 m Torr before running the tests.

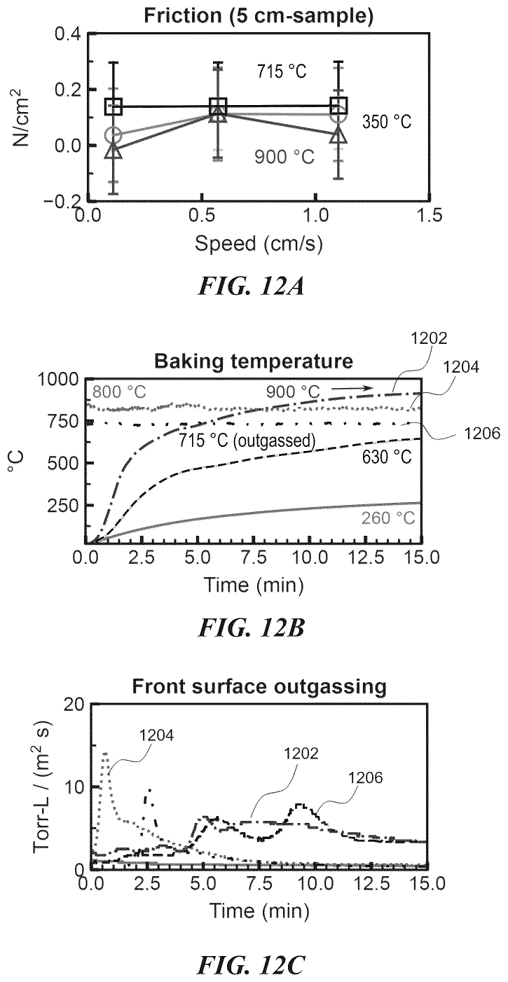

FIGS. 12A-12C show friction force and outgassing rates in the extrusion system, showing (FIG. 12A) friction force as a function of extrusion speed, (FIG. 12B) baking temperature as a function of time for different experiments, and (FIG. 12C) resulting front-surface outgassing for the different baking temperatures shown in FIG. 12B.

FIG. 12A shows the friction force between the slurry and the stainless steel extrusion tube. The force has been normalized by the contact area of the slurry. The results show a friction force in the order of the uncertainty and almost no variability with either the extruding speed or the bake-out temperature. The average friction accounts for (0.1±0.2) N/m². For a target tube length of ≈1 m, the expected friction between the slurry and the stainless steel tube is <50 N.

In some implementations, the pressure in the bake-out and end chambers is monitored throughout the process to study the front surface outgassing during bake-out. Both stages use independent pumping and pressure monitoring systems. Volatile byproducts of the baking process are pumped out in the bake-out chamber shown in FIG. 11A via venting holes in the extrusion tube. Accordingly, in the end section, the pressure is observed to be an order of magnitude less than the pressure in the bake-out chamber. In these experiments, the sample is stopped in the baking section, i.e., the extrusion speed is zero during the bake-out process. The front-surface outgassing rate is calculated from the extrusion tube cross-section, measured second chamber pressure, known second chamber volume, and measured second chamber pumping speed.

The front surface outgassing curves for samples baked at the various temperatures shown in FIG. 12B are depicted in FIG. 12C. Generally, at temperatures higher than ≈600° C., the outgassing rate reaches its peak and then drops. In some experiments (e.g., curves 1202 in FIG. 12B and FIG. 12C), the baking section temperature is ramped after the sample arrives, while in others (e.g., curves 1204) the baking section temperature is left high. This study shows that the time required to reach peak outgassing rate can be reduced by leaving the baking section hot; this scenario more accurately reflects a closed-loop system where the heating section is maintained hot continuously. FIG. 12C also shows that volatile species are depleted from the system in a timescale <2.5 min, which is compatible with an extrusion tube of length <1 m at the extrusion speeds targeted.

The magnitudes of the peak front-surface outgassing were less than 20 Torr-L/s/m². As will be discussed later, these rates are well below levels needed for application in a tokamak reactor divertor. The curves 1206 labeled “outgassed” in FIG. 12B and FIG. 12C correspond to an experiment where the carbon pebbles were baked out in advance of being formed into a slurry. This is shown to reduce peak outgassing and is expected to reflect a closed-loop system where the pebbles are continuously under vacuum.

### Laser System

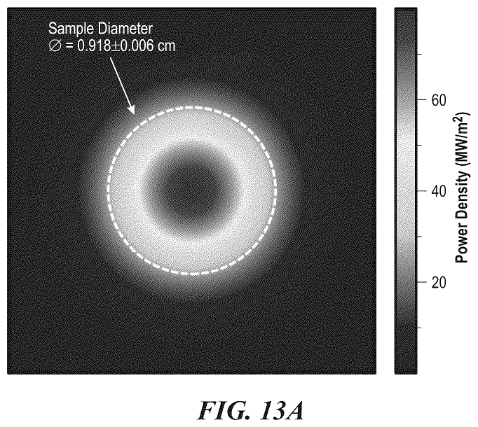

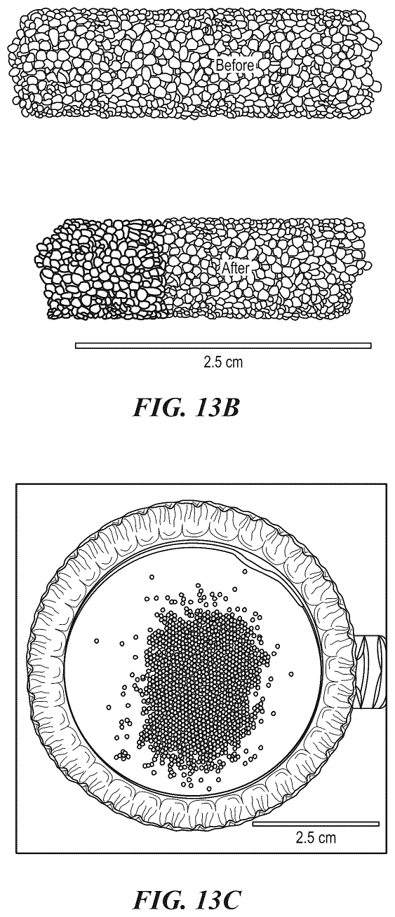

FIGS. 13A-13C show typical effect of the incident Gaussian beam on a pebble rod, illustrating (13B) front surface aggregate recession and (13C) pebble recovery.

The expected Gaussian profile of the laser beam at the output of the 1.5× beam expander is shown in FIG. 13A. The beam waist radius w_{z} was estimated to be ≈0.6 cm. For scale, the diameter of a typical sample is shown by the dashed circle in FIG. 13A. In some embodiments of the disclosed technology, w_{z} is held fixed, and in some implementations, sample characteristics may be used as a function of mean beam power averaged over the sample.

FIG. 13B shows a typical sample before and after being exposed to the beam shown in FIG. 13A. There is a noticeable change in the length of the irradiated sample; this length change can be used to calculate a mean “recession rate” (or pebble loss rate, i.e., recession speed of front surface), which is found to be consistent with recession rate estimates made using mass loss (discussed later).

The pebbles that detach from the sample due to the heat load of the laser are collected in a tray on the floor of the chamber. A squared grid with 12.7 mm spacing is placed over the collecting tray to capture the final positions of the ejected pebbles, which are used to determine the pebble ejection velocity at high heat loads. The pebbles are released from the front surface at low velocity (<10 m/s) and are dominantly recovered intact, as shown by a photo of recovered pebbles in FIG. 13C.

The heat load at the surface of the specimens was estimated using three different methods, all of which are found to be in reasonable agreement: (1) Gaussian optics using known laser characteristics, (2) infra-red (IR) thermography, and (3) thermocouples.

For the thermography measurements, an achromat doublet was used to focus the light radiated by the heated sample into an optical fiber, pass it through a ≈10 nm bandpass filter centered at ≈910 nm, and deliver it to a biased silicon photodetector. The system was absolutely calibrated using a calibrated light source. For the purposes of thermography analysis, the pebble rod IR emissivity was assumed to be the same as that of graphite.

For the thermocouple measurements, type-K thermocouples are clamped to the side of the samples at different axial positions. The surface heat flux is then estimated from a best fit of the thermocouple data to a numerical heat transport model. The time response of the thermocouples used here (1.6 s) is comparable to experimental time scales, so the thermocouple data need to be corrected using:

$$T ( t ) = {T}_{m} ( t ) + {τ}_{c} \frac{d}{dt} {T}_{m} ( t ) , \qquad ( 1 )$$

where Tₘ is the temperature measured by the thermocouple, τ_{c} is the thermocouple time constant, and T(t) is the actual (corrected) temperature.

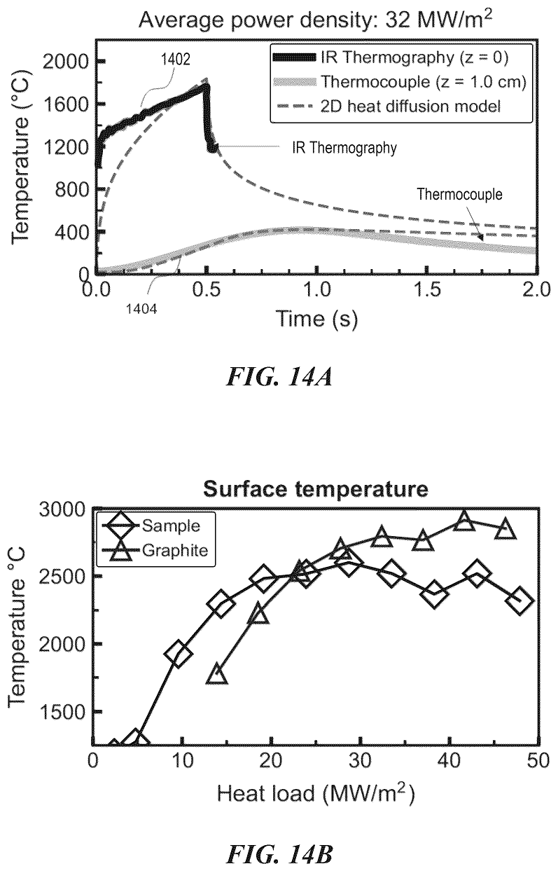

FIGS. 14A-14B show measurements of sample surface temperature including cross-checks between thermocouple and IR thermography diagnostics, showing (FIG. 14A) temperature at axial positions Z=0 (measured with thermography) and Z=1.0 cm (measured with thermocouple), as well as model fits as a function of time, and (FIG. 14B) measured equilibrium surface temperature as a function of surface heat load for pebble rod sample and graphite reference sample.

FIG. 14A shows the temperature at the surface exposed to the laser (estimated using IR thermography) as a function of time 1402, as well as the corrected temperature measured by a thermocouple at z=1.0 cm, i.e., 1.0 cm away from the front surface (along the axis of the rod) 1404. The dashed lines represent the results from a numerical simulation for the input power density that fits best the experimental data. The estimated average front-surface heat flux from the fit corresponds to (32±4) MW/m², which, within the error bars, matches the heat flux estimated using Gaussian optics.

The temperature at the surface of the specimen Tₛ (t) is observed to reach a maximum flattop value T_{ft} upon exposure to the laser and remains at T_{ft} until the laser is shut down, suggesting that equilibrium has been reached. The flattop temperature and the time required to reach T_{ft} are found to depend on (a) the heat load and (b) the sample composition. FIG. 14B shows the flattop temperature at the surface of pebble rods as a function of the laser heat load, indicated as the trace with open diamonds. As a reference, the surface temperature of a graphite rod is shown, indicated by the trace with open triangles. The graphite rod is observed to reach a slightly higher temperature at the surface (≈2900° C.) than the pebble-based sample (≈2500° C.). Both the graphite reference and the pebble-based sample have a cylindrical geometry with a diameter of (0.918±0.006) cm. The graphite reference rod was made of isostatically pressed graphite.

FIG. 14B also suggests that the pebble rod is able to withstand a heat load of ≈15 MW/m² before reaching a flattop temperature value T_{ft} of ≈2500° C. Beyond this threshold heat load, the temperature no longer depends on the input heat load. For the graphite rod, this threshold is slightly higher (≈30 MW/m²). The lower threshold for the pebble-based sample is indicative of a lower thermal conductivity due to poor thermal conduction between adjacent pebbles. Additionally, the lower flattop temperature of the pebble-based sample suggests that some of the heat is being taken away by carbon pebbles which detach from the surface of the sample during exposure to high heat loads.

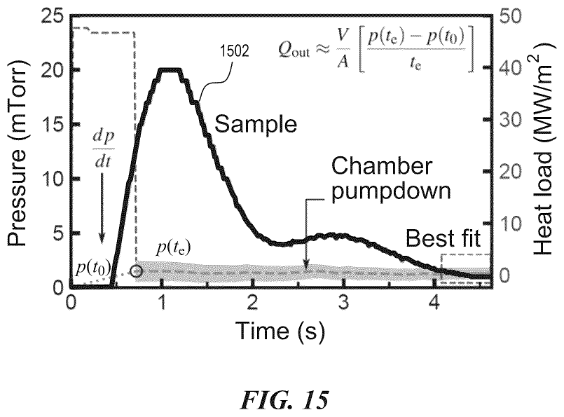

FIG. 15 shows estimation of sample outgassing under laser heat load. Vis the volume of the chamber and A is the front surface area of the sample. Specifically, FIG. 15 shows measurements of chamber pressure pₕᵢ (t) during exposure of samples to a laser heat load of ≈45 MW/m² (1502). pₕᵢ (t) corresponds to the pressure of volatile gas species sensed by the pressure gauge away from the line-of-sight of the sample. Non-volatile (carbon) release by sublimation will be discussed separately. The purple (dashed) trace in FIG. 6 corresponds to the pressure of the chamber during pump-down at room temperature p_{pd}. The red-dashed trace in FIG. 15 corresponds to the heat load of the laser pulse. To estimate the particle release during the laser pulse, we assume that the gas is at room temperature by 4 s and fit the steady-state pump down rate p_{pd} (t) over 1=4 to 5 s (marked as “Best fit” region in FIG. 15). We use this fit to extrapolate the value of the expected pressure at room temperature back at the end of the laser pulse p(tₑ). The hydrocarbon release during the laser pulse is assumed to be constant, giving a linear rise in room-temperature pressure. The measured pressure rise and decay are quite different than this room-temperature curve for t≤4 s, indicating hot, non-isotropic gas.

The ejection velocity of carbon pebbles due to laser heating was estimated from their final positions on the gridded collecting tray using a simple kinematic equation v_{z}=r\sqrt{g/2x₀}, where z is the axis of the sample, X₀ is the height of the sample (X=12.7 mm), g the gravitational acceleration, r=\sqrt{(y−y₀)²+(z−z₀)²} and (y₀, z₀) is the position of the sample. For low heat loads, the number of recovered pebbles is usually less than 5, which makes the statistics at heat loads (5<Q<25 MW/m²) slightly biased toward greater exit velocities. Using this estimation, the average pebble velocity at ≈50 MW/m² is ≈30 cm/s, with a maximum value of ≈60 cm/s.

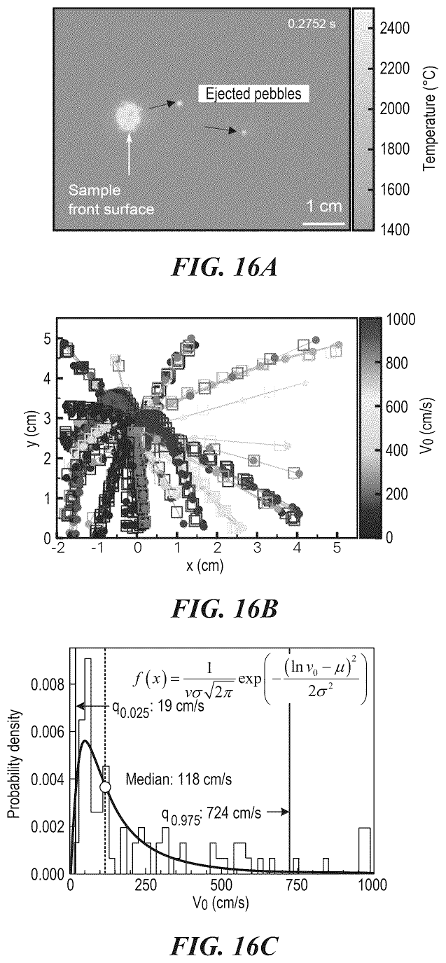

FIGS. 16A-16C show pebble ejection velocity from NIR thermography imaging. Specifically, FIG. 16A shows NIR image of two pebbles being ejected from the surface of the sample at 45 MW/m², FIG. 16B shows best fit of several pebble trajectories ejected from a sample subject to a 45 MW/m² heat load, and FIG. 16C shows distribution of pebble ejection velocities.

Particles ejected from the sample during laser exposure were also tracked using a near-infrared (NIR) imaging system with a framerate of 200 Hz. The camera dominantly images light in the 800-900 nm range, with a short-pass filter at 1025 nm used to block reflected laser light. FIG. 16A shows a NIR image of two pebbles ejected from the sample during laser irradiation with a heat load equivalent to 45 MW/m². The temperature scale of FIG. 16A is estimated using absolute cross-calibration with a calibrated light source and assuming an emissivity of 0.9 for the pebble rod material. The cumulative positions of the pebbles during a typical laser exposure are depicted as solid circles in FIG. 16B. The ejection velocity v₀ was estimated from the best fit of the pebble trajectories to a simple kinematic model. The predicted positions are shown in FIG. 16B as empty squares with the color scale indicating the fitted value of v₀. FIG. 16C shows a histogram of v₀ upon exposure of the samples to laser heat loads. The distribution of v₀ is largely skewed but is well described by a log-normal probability density function, with a mode at 50 cm/s and a median at 118 cm/s. q_{0.025} and q_{0.975} represent the 2.5 and 97.5 percentiles of the distribution which are used as error bounds.

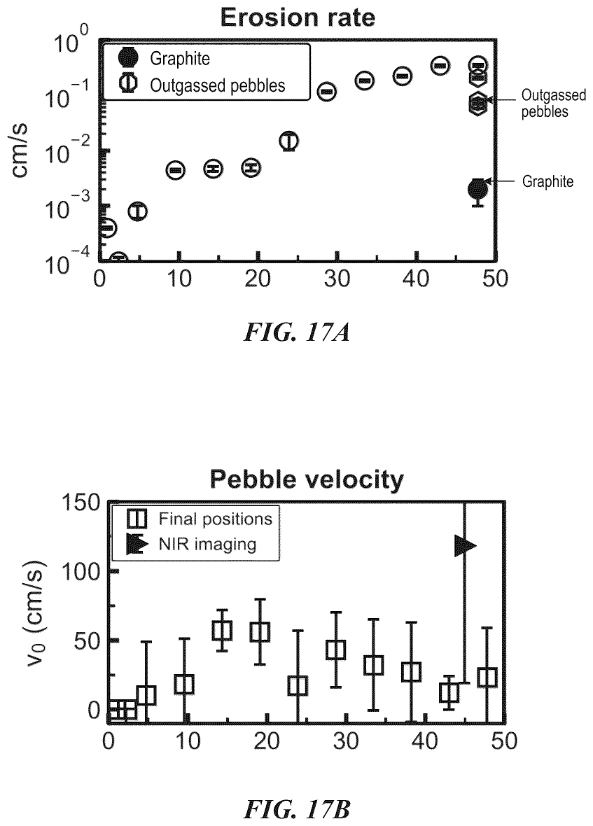

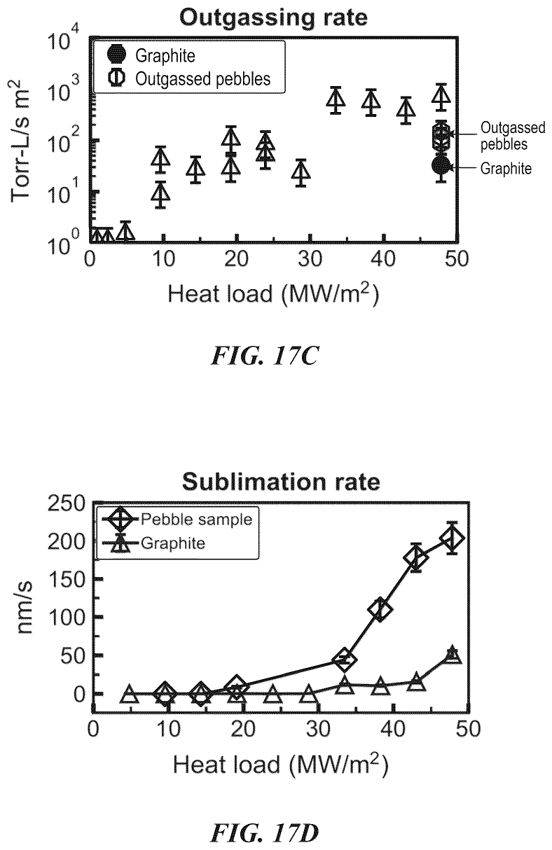

FIGS. 17A-17D show behavior of pebble samples at different front-surface heat loads including front surface recession (erosion) rate, ejected pebble velocity, front surface outgassing rate, and front surface sublimation rate. Specifically, FIG. 17A shows front-surface recession rate, FIG. 17B shows the pebble ejection velocity, FIG. 17C shows front-surface outgassing rate, and FIG. 17D shows average sublimation rate from the pebble rod front-surface (average sublimation rate of pebble rods as a function of front surface heat flux).

FIG. 17A shows the front-surface recession rates of pebble-based specimens at different heat loads. To estimate the recession rate of the tested specimens, the mass of the specimens was measured before and after exposure to the laser. The recession rate h is determined by

$$h = \frac{4 Δ m}{ρπ {d}^{2} {t}_{e}} , \qquad ( 2 )$$

where Δm is the change in the specimen mass after being exposed to the laser heat load, t_{c} is the length of the laser pulse, and p and d are the density and diameter of the specimen, respectively. Front-surface recession starts becoming a significant (>0.1 cm/s) at heat loads greater than 25 MW/m² and reaching up to ≈0.4 cm/s at heat loads of ≈50 MW/m². An average recession rate of 0.2 cm/s was estimated at heat loads of ≈50 MW/m².

The mean pebble ejection velocity at different heat loads is shown in FIG. 17B. Pebble velocities estimated from the final positions of the pebbles are marked in empty orange squares and a single estimation from NIR thermography is shown by the brown triangle. These measured velocities are not expected to cause significant core fueling, which requires pellet velocities of the order of several 1000 m/s in a reactor-class tokamak.

FIG. 17C shows the outgassing rates of pebble samples as a function of the heat load. At heat loads lower than 30 MW/m² the outgassing rate lies below 120 Torr-L/s/m². However, beyond 30 MW/m², the outgassing straddles 600 Torr-L/s/m². As a reference, the outgassing of graphite at a heat load of ≈50 MW/m² shown as a full circle is ≈30 Torr-L/s/m². An approach to reducing outgassing consists of heating the pebbles under vacuum (pre-outgassing) prior to the extrusion of the specimens. This approach considerably reduces the outgassing at ≈50 MW/m² down to ≈150 Torr-L/s/m² as seen in FIG. 17C for the data points indicated in open magenta hexagons.

FIG. 17D shows the rate of carbon sublimation in pebble-based specimens at different heat loads (diamonds in FIG. 17D). The rate of sublimation from the pebble rod front surface was estimated from the thickness of carbon deposits measured on a witness plate mounted in front of the pebble rod after one laser exposure. The thickness of the carbon deposit was estimated by Beer's law using transmission data at 650 nm. An extinction coefficient k ≈0.3 was used for deposited carbon films at the diagnostic wavelength of 650 nm. It is observed that sublimation is negligible for heat loads lower than 30 MW/m² and reaches up to ≈250 nm/s at heat loads ≈50 MW/m². For comparison, the sublimation rate of graphite at different heat loads is shown in triangles. In contrast to the pebble-based sample, graphite sublimates carbon at a slower rate, with sublimation becoming significant at heat loads greater than 40 MW/m² and reaching rates of less than 50 nm/s at ≈50 MW/m².

### Simulation of Sample Disintegration

To support the experimental study, computational models of the pebble rod front-surface recession under laser heating were developed. This computational effort aims to help guide the present benchtop experiments; and, ultimately, predict concept performance in reactor conditions.

### A. Methodology

Consistent with experimental observations, the simulations assume that front-surface recession occurs primarily due to damage in the binder material, and is driven by thermal stresses caused by thermal gradients across the pebble rod and differential thermal expansion in its constituents. This requires solving for coupled heat transfer and mechanical deformation, using a model that explicitly includes the heterogeneous structure of the composite. In addition, the ability to remove material as it is ejected from the heated surface and update the boundary where heat flux is applied is required. The Multiphysics Object Oriented Simulation Environment (MOOSE) was employed to meet these needs. MOOSE is an open-source finite element (FE)-based framework that has been used extensively as the basis for simulation of fuel in fission reactors. The modular structure of MOOSE readily permits multiphysics simulations and the incorporation of application-specific models such as those used here for material removal.

In some implementations, a combination of 2D and 3D models can be used. The modeling approaches used here are equally applicable to 2D or 3D models, but 2D plane strain simulations are used in some aspects of this early-stage demonstration for decreased complexity and computational expense. The 2D modeling assumption is expected to introduce some errors, which will be quantified in future studies using 3D models for comparison. Still, these errors are not significantly larger than those introduced by other modeling assumptions.

In the FE models, the carbon spheres were explicitly represented and embedded in a continuous matrix composed of the binder, filler, and vacuum voids. The discrete element method (DEM) capability within the LAMMPS Molecular Dynamics Simulator was used to randomly arrange these spheres in the cylindrical sample. DEM is a widely accepted approach for modeling the flow of granular materials. In the LAMMPS model, oversized rigid spheres (with a radius chosen to give the desired volume fraction of the actual spheres after packing) were poured into a cylindrical container under gravity, and the resulting locations of the sphere centers were used to define the geometry of the three-dimensional (3D) FE mesh. A similar process was adopted to obtain two-dimensional (2D) meshes for simplified analyses. Linear tetrahedral elements were used in the FE meshes for the 3D simulations, while linear quadrilateral elements were used for 2D simulations.

The thermal portion of the FE model accounts for heat transfer within the body through conduction, with different properties for the carbon spheres and homogenized matrix material. A boundary condition to apply heat flux from the laser was employed on the front surface. Radiant heat loss is allowed from all exposed surfaces. Heat is also lost as pebbles are removed, but sublimation heat loss is not included yet.

In the mechanical portion of the model, pebbles are assumed to remain intact and are treated as linearly elastic. A damage model using a smeared cracking approach, which permits the formation of cracks in three orthogonal directions based on the directions of the principal tensile stresses, is used for the matrix material. To simulate front surface recession, matrix material is removed from the computation domain once it gets damaged beyond a threshold level. In addition, material that is surrounded only by fully damaged matrix material should be removed because it is no longer connected to the rest of the domain. This is accomplished by using the algorithm developed to identify the portion of the model connected to the un-damaged region at the top of the model, and all other material is deleted. As part of this process, the evolving free surface of the un-damaged region is updated and used for the application of boundary conditions. A custom procedure was developed to only apply the heat flux to surfaces with an unobstructed view of the laser.

### B. Parameter Estimation

Key parameters for modeling the thermo-mechanical behavior of the sample under laser heating include the volume fractions of the carbon spheres and matrix and their thermal and mechanical properties. Experimentally observed densities of the carbon spheres, binder, and overall sample are 1.35, 1.35, and 0.9 g/cm³, respectively. Based on these densities, the volume fraction of air (or vacuum) in the sample is 0.33. The volume fractions of carbon spheres and binder in the sample were estimated to be 0.13 and 0.53. The volume fraction of carbon spheres was used to obtain the total number of spheres to be inserted in the simulation domain. The diameter of the carbon spheres is 0.8 mm.

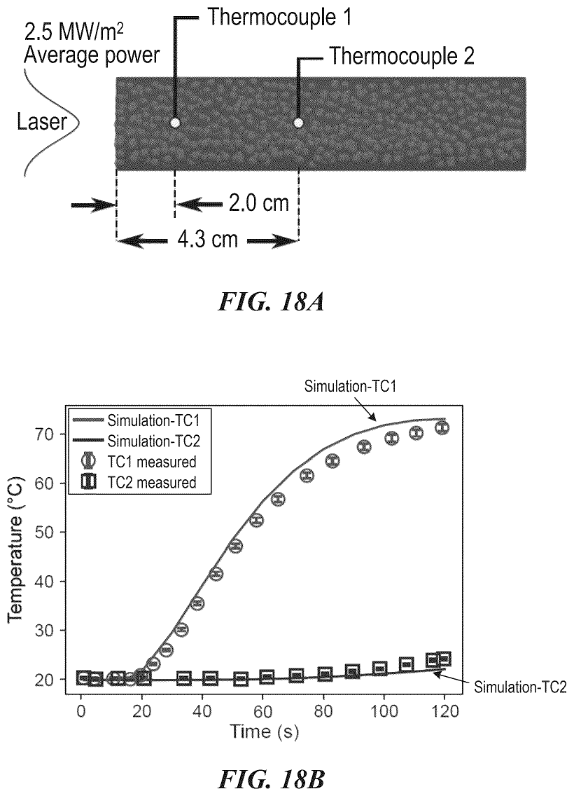

FIG. 18A shows 3D simulation of the low-power laser heating test to obtain thermal properties of the sample. FIG. 18B shows comparison of experimental thermocouple temperature histories with MOOSE-simulated values.

Material properties were estimated using a combination of values from literature (for the carbon spheres) and experimental studies (for the matrix). For example, thermocouple data from a low-power laser heating test, combined with MOOSE simulations, allows an estimate of the matrix thermal conductivity to be made. Laser heating with an average flux of 2.53 MW/m² was applied at one end of the pebble-based sample. The homogenized thermal diffusivity a of the pebble-based sample was estimated to be 1.29×10⁻² cm²/s, based on a least-squares fit to a heat diffusion model of the time-dependence of the temperatures of two thermocouples placed along the axis of a 5 cm-long specimen, at z=2.0 cm and z=4.3 cm from the front surface of the sample, as shown in FIG. 18A.

A MOOSE simulation of the low-power heating test, using the 3D model shown in FIG. 18A, was used to obtain matrix thermal properties. In this model, thermal properties of the spheres were taken from literature values of graphitic materials. The thermal conductivity, heat capacity, and thermal expansion coefficient of the spheres were assumed to be 7.95 W/(m-K), 850 J/(kg-K), and 2×10⁻⁶ K⁻¹, respectively. For the matrix, a heat capacity of 937 J/(kg-K) was hand calculated based on the weight fractions of the materials that comprise the binder composite and available data for carbon-based materials. The thermal conductivity of the matrix was considered to be a free parameter in the simulation. Temperature profiles from the simulation were matched to the experimental observations and led to an estimation of the thermal conductivity of the matrix to be 0.16 W/(m-K), as shown in FIG. 18B. In the absence of additional data, the thermal expansion coefficient of the matrix was assumed to be the same as that of graphite powder (i.e., 7.86×10⁻⁶ K⁻¹).

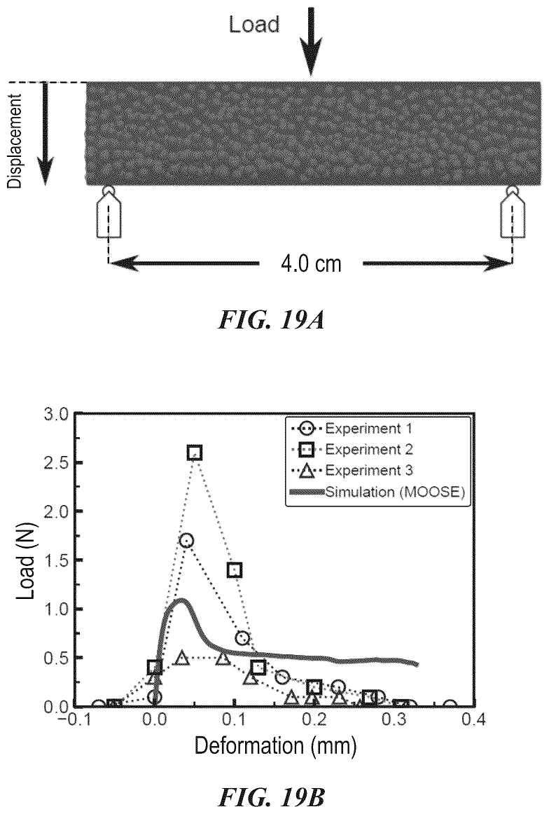

FIG. 19A shows a 3D MOOSE simulation of the 3-point beam bending test of a pebble rod sample. FIG. 19B shows comparison of load-displacement response from experiments and simulation in MOOSE.

Bending/breaking tests were used to estimate the Young's modulus and breaking strength of the matrix. The Young's modulus and Poisson's ratio of the spheres were assumed to be 32.4 GPa and 0.155, respectively. The Poisson's ratio of the matrix was assumed to be the same as that of the graphite powder (i.e., 0.21). The Young's modulus and tensile strength of the matrix were estimated by testing the composite sample on a three-point bending setup as shown in FIG. 19A, combined with MOOSE simulations. Due to the brittle behavior of the sample, only a few data points could be collected in the experiments before failure. As seen in FIG. 19B, there is significant scatter in the experimentally observed bending strength. The simulation results shown in FIG. 19B are based on Young's modulus and cracking strength of the matrix of 70 MPa and 25 kPa, respectively, and fall within the bounds of the experimental data. Elements were deleted from the simulation when the sum of the damage index (ranging from 0 for no damage to 1 for fully damaged in a given direction) in three orthogonal directions exceeded a prescribed value, which was calibrated to 1.05 with this test. This same threshold for element deletion was used in the laser heating simulation. There is considerable uncertainty in the tensile strength of the matrix material, partly due to the variations in the matrix-pebble binding environment. Together with fluctuations in plasma heat flux, it is expected that the net result will be a mean recession rate at each location, with a wide scatter around this mean.

### C. Laser Exposure Simulation

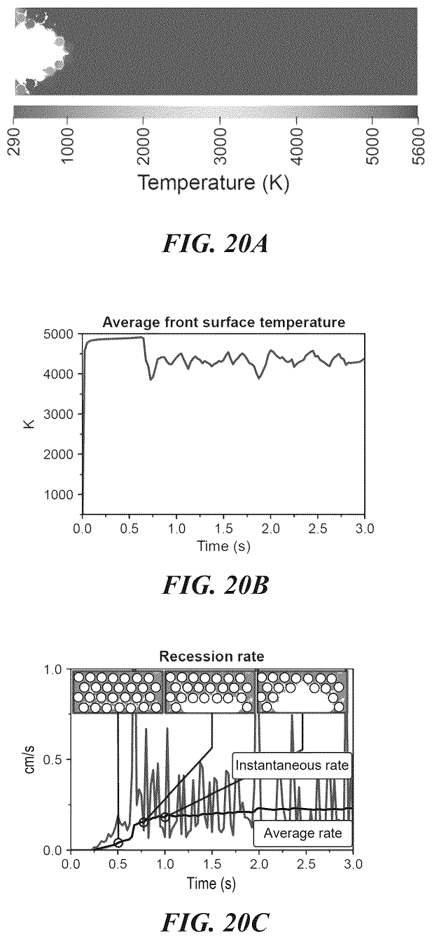

FIG. 20A shows 2D simulation of the response of the pebble rod to laser heating. FIG. 20B shows average temperature of the exposed front surface. FIG. 20C shows simulated temporal rate of front-surface recession, with snapshots of the remaining material near the exposed (bottom) surface of the model at selected times.

A snapshot of the simulated response of the sample under exposure to the laser beam is shown in FIG. 20A. This demonstrates the material front-surface recession, with only active material being shown, and temperature contours in the domain. Localized regions on the front surface experience a high temperature close to 10+K. However, the average temperature on the front surface is about 4500 K, as shown in FIG. 20B. The average temperature is calculated on the surface exposed to the laser. The recession rate of the sample is shown in FIG. 20C. Both “instantaneous” and average (time-integrated) recession rates are plotted. Recession rates are calculated based on the change over time of the volume of deleted material divided by the specimen's cross-sectional area.

The average temperature of the sample at the exposed surface increases initially but then approaches a constant value of about 4000 K. This indicates that the rate of heating of the sample and the rate of cooling due to front surface recession and heat transfer from conduction and radiation compensate for each other. The recession rate averaged over the 1 s laser exposure, can be seen to be of order 0.2 cm/s, in reasonable agreement with experimental observations.

The disclosed technology can be implemented in some embodiments to provide a low-Z divertor first wall material that will allow tritium recovery while also allowing handling of reactor-relevant heat loads and avoiding excessive wall thickness changes due to plasma erosion. The data disclosed in this patent document suggest that the basic pebble rod tested here has promising characteristics but is not yet, in its present form, suitable for use in a reactor. Basic estimates based on carbon heat capacity arrive at a required pebble rod recession rate of around 1 cm/s to handle steady-state outer leg heat loads of ≈40 MW/m². Similar basic estimates arrive at a required pebble rod recession rate of about 0.02 cm/s to avoid strong sublimation at steady-state inner leg deposition region heat loads of ≈1 MW/m². In contrast, we achieve here a pebble rod recession rate of ≈0.2 cm/s at ≈40 MW/m² and ≈0.001 cm/s at ≈1 MW/m². Pebble rod recession rates required for tritium recovery and physical/chemical sputtering resistance are estimated to be much less stringent (<0.01 cm/s) and are therefore automatically satisfied if heat load requirements are met.

The insufficient pebble rod recession rates achieved here manifest themselves in various ways in the data. One manifestation is the lower onset of the flattop temperature region for the pebble-based sample seen in FIGS. 14A-14B when compared with graphite; this is attributed to a poor thermal conduction mechanism between the constituent pebbles and a higher void fraction in the pebble-based sample (p=(0.918±0.006) g/cm³) compared to graphite (p=(1.723±0.009) g/cm³). With a sufficiently high recession rate, it is expected that the reduced inter-pebble thermal conduction will be compensated for by the heat carried away by the falling pebbles.

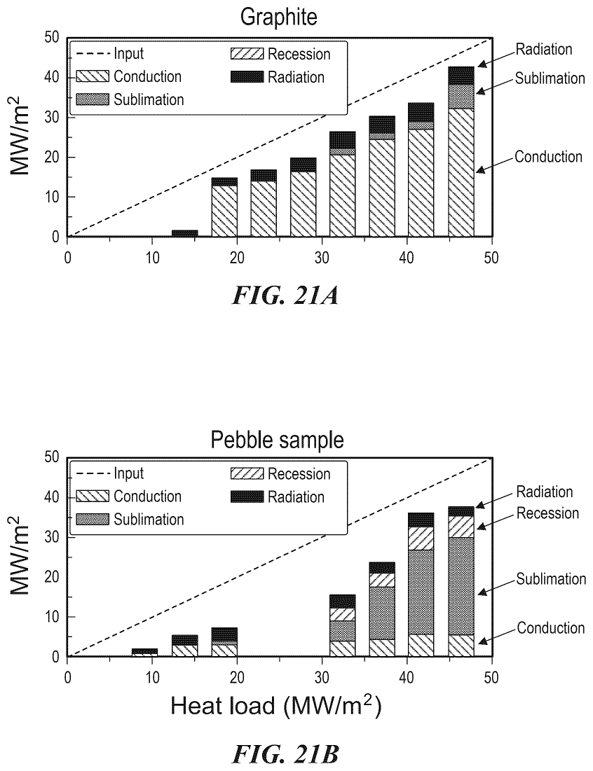

FIGS. 21A-21B show estimated power balance of specimen subject to laser heating for (FIG. 21A) graphite reference sample and (FIG. 21B) pebble-based sample, including data on laser input power, conducted power loss, sublimation power loss, radiated power loss, and power loss due to ejection of heated pebbles (recession power loss).

Power balance estimates of different cooling pathways were made here to illustrate the different cooling mechanisms at work and compare the performance of the pebble-based sample with the reference graphite sample. FIGS. 21A-21B illustrate the components contributing to heat loss during laser heating at different heat loads. Due to the higher thermal conductivity of graphite, the diffusion length in Eq. (3) is longer, and conduction to the bulk becomes the predominant heat loss mechanism around the surface of graphite, followed by radiative losses and sublimation (at high heat loads) as illustrated in FIG. 21A.

The conductive heat loss P_{c} into the bulk of the sample can be approximated by measuring the change in temperature within the thermal diffusion length of the material

$${P}_{c} ≡ \frac{{c}_{v} ρ ( 2 \sqrt{{α1τ}_{ft}} )}{{τ}_{ft}} Δ T , \qquad ( 3 )$$

where Cᵥ is the specific heat of the sample, T_{ft} is the amount of time the specimen was subject to the flattop temperature shown in FIGS. 14A-14B and ΔT is the difference between the flattop T_{ft} and initial temperature 10. A thermal diffusivity of ∝=1.29×10⁻² cm²/s was used, according to the experimental estimation discussed in section V B.

The heat taken away from the sample due to sublimation of carbon can be approximated from the amount of carbon deposited on the wall opposite to the sample surface: p_{c}πd_{film} (L arctan θ)², where P_{c} is the density of graphite, d_{film} is the average thickness of the carbon deposit, L is the distance between the surface of the sample and the wall, and θ is the angle of the deposition cone, determined to be θ≈35°.

Sublimation cooling can be approximated as

$${P}_{s} ≡ \frac{{ρ}_{C} π {{d}_{film} ( L arc tan θ )}^{2}}{{τ}_{ft}} Δ {H}_{s} , \qquad ( 4 )$$

where a heat of sublimation of ΔHₛ=177 kcal/mol is used.

Front-surface recession cooling is estimated as

$${P}_{e} ≡ h ρ {c}_{v} Δ T \qquad ( 5 )$$

The radiative component to the heat loss is given by

$${P}_{r} = {σ}_{sb} ε ( {T}_{ft}^{4} - {T}_{0}^{4} ) , \qquad ( 6 )$$

where σ_{sb} is the Stefan-Boltzmann constant and ε is the emissivity of the material. As a first approximation, a value of ε=1 was used.

In the pebble-based sample, thermal conductivity is low, leading to heat accumulating near the surface and hence reaching carbon sublimation at lower heat loads as illustrated in FIG. 21B. However, for the pebble-based specimen, detachment of pebbles shown in FIGS. 13C and 17B becomes an important mechanism at heat loads larger than 30 MW/m², overtaking radiative losses.

In terms of surface outgassing, the existing slurry already achieves surface outgassing rates that are tolerable, <1000 Torr-L/s/m². Surface outgassing rates that can be tolerated without adversely affecting tokamak core performance will depend strongly on the gas emission area and location, tokamak size, and discharge parameters. The divertor heat flux width is still poorly understood and extrapolations to future devices are still an area of research. For example, the entire divertor area of large tokamaks like DEMO could amount to up to 80 m². However, the area experiencing high heat fluxes is much smaller, as it is in the case of DEMO, which targets divertor heat loads of ≈20 MW/m² and conducted plasma heat loads of 100 MW, giving a high flux region of order 5 m². Typical operational (hydrogenic) core fueling rates are of order 10 Torr-L/s in present medium-sized tokamaks and will be of order 1000 Torr-L/s in future reactor-sized tokamaks. Core fueling efficiency for edge puffing is typically quite poor depending on plasma conditions, ranging from 0% directly at divertor strike points, moving up toward 10% or higher further away from the tokamak divertor. As a rough figure of merit, we therefore use 1000 Torr-L/s/m² as an upper tolerable areal outgassing level for a divertor-based reactor wall material in some embodiments of the disclosed technology For example, assuming 1000 Torr-L/s/m², areal outgassing rate, a high-flux region coverage of 10 m² and a fueling efficiency of 1% gives a core fueling rate of 100 Torr-L/s, which should not be a strong perturbation to the reactor core (assuming dominantly hydrogenic outgassing).

In some embodiments of the disclosed technology, 1000 Torr-L/s is also a reasonable outgassing upper bound assuming that hydrocarbons are released from the surface (instead of hydrogen). Carbon chemical erosion under hydrogen ion bombardment tends to emit CH₄ for ion energies greater than 10 eV, and heavier species C₂Hx for lower ion energies less than 10 eV (Roth). Assuming an emitting area of 10 m², a fueling efficiency of 1%, an emitted hydrocarbon C/H ratio of 1/3, and similar hydrogen and carbon ion transport rates, an equilibrium core C concentration of order 3% could be expected. This remains below the 5% C concentration in high-performance DIII-D discharges and 10% allowable upper limit in a tokamak fusion reactor.

In some embodiments of the disclosed technology, fairly large (mm-sized) pebbles are used. Pebble acceleration or entrainment in the divertor plasma is, therefore, not expected to be an issue. Previous studies have found that gravity is expected to dominate all other forces (electric field, ion drag, and ablation pressure) for particles much larger than the Debye length, which is typically <1 mm in tokamak plasmas.

In this concept, degradation of pebble material properties due to neutron impact is not expected to be a concern. For example, degradation of the thermal conductivity of carbon due to neutron damage has been studied previously, with a 90% reduction after a 0.01 dpa damage, and 15% reduction. However, pebbles will only be briefly exposed to plasma heating since the front surface is expected to recede at a rate of ≈1 cm/s, limiting the severity of neutron damage. Slightly damaged carbon (with damage levels under 0.1 dpa) can readily recover full thermal conductivity upon annealing at 1300 K. The wall heat flux of neutrons in a reactor is expected to be about 1 MW/m², consisting dominantly of 14 MeV neutrons from D+T reactions. For carbon, 1 dpa corresponds to roughly 1025 n/m², suggesting that it would take ≈1 day of exposure to reach a 0.01 dpa damage. In a closed loop, the duty cycle of pebbles exposed to plasma is expected to be brief (of order 1 s per cycle), in which case pebbles will require full annealing every few weeks, which would be achieved easily during pebble recycling by contact with hot surfaces in the main chamber and pebble pumping ducts. Carbon swelling due to radiation damage, might be less of a concern, since doses larger than 30 dpa are required to achieve 5% volume changes, which would take months under exposure to reactor plasma, and may be years for the proposed duty cycle.

The disclosed technology can be implemented in some embodiments to provide a method for tritium extraction. The system based on an implementation can act as a complete substitute for a divertor pumping system. The system based on another implementation does not act as a complete substitute for a divertor pumping system. The main purpose of pebble rods is to prevent the formation of carbon co-deposits which trap tritium and prevent it from being pumped out. For a fusion reactor, core fueling requirements are of order 1000 Torr-L/s. In steady state, the pumping rate of hydrogen and helium coming out should be close to this number. In a reactor divertor, plasma hydrogen fluxes to walls are of order 10²¹ cm-2s-1. Under these conditions, carbon surfaces saturate on a sub-ms timescale over the implantation depth of hydrogen. Carbon pebbles are therefore almost instantly saturated and cannot absorb any more hydrogen. The implantation depth is of order 0.5 nm for 10 eV and the saturated fraction is of order 0.4 H/C. Assuming a deposition region in the divertor of order 50 m² and a flow rate of 1 mm/s, the hydrogen pumping rate is of order 50 Torr-L/s, which is small compared with the required pumping rate. This concept, therefore, does not replace the reactor pumping system. For high-quality carbon, with low porosity, thermal release will be low below 1000 K, and heating above this threshold will be required. Alternatively, highly porous carbon could be used, allowing tritium to diffuse at lower temperatures. If boron is adopted instead of carbon, tritium extraction might be expected at even lower temperatures since hydrogen diffuses out of boron at temperatures below 700 K.

The mechanical systems required to assist pebble recovery will depend on the reactor geometry and still need to be outlined. However, initial recovery would act by gravity through recesses in the reactor floor into recovery beds. Shielding could partially protect the mechanical systems from the 1 MW/m² main chamber neutron flux. Worm drives or gears to push pebbles along would need to be made from high-Z neutron-resistant materials like RAFM steels or SiC. Overall, pebble recovery is not expected to be fundamentally more difficult than many other fusion reactor blanket or first wall challenges.

If tritium co-deposition in shadowed areas proves a major concern, other low-Z materials could be used instead of carbon to mitigate this issue. For example, boron has a lower Z than carbon which gives a better core performance, and chemical erosion rates of boron under hydrogen bombardment are 10× smaller than carbon. A smaller amount of volatile species are produced with boron under hydrogen bombardment than with carbon, leading to a more limited spatial extent (and easier mitigation) of co-deposition in shadowed divertor regions. Additionally, hydrogen desorption from boron occurs at only 400 K, which makes it suitable for mitigating tritium co-deposits. Boron carbide is also a good alternative to carbon. A potential concern is that boron is a strong neutron absorber, which could reduce tritium breeding efficiency, but this concept is envisioned to cover only the divertor region and therefore will not block the tritium breeding blankets behind the main chamber outer wall. If necessary, this issue could be addressed by using B-11 enriched boron, which is available commercially. Silicon carbide is an interesting alternative for this concept because of its excellent neutron-handling properties. High-Z materials like steel are expected to give a worse core performance so are not as desirable for this concept.

In some embodiments of the disclosed technology, the sublimation of carbon at high temperatures remains challenging. As shown in FIG. 17D, sublimation takes off above heat loads of order 15 MW/m², with sublimation rates becoming intolerably high. A sublimation rate of 100 nm/s corresponds roughly to an outgassing rate of 30× the 1000 Torr-L/m²/s threshold (although there is large uncertainty in this estimate, from uncertainty in the area over which carbon is deposited). The thermal conductivity of the composite could be increased to allow cracking of the matrix binder deeper in the bulk of the rod, releasing the pebbles before they reach sublimation temperatures. The disclosed technology can be implemented in some embodiments to increase front surface recession rates for better heat management.

The first wall design is a formidable challenge for MFE reactors. Here, first research is presented toward the development of a low-Z pebble rod-based first wall concept. The wall design is suitable for use in a tokamak or stellarator reactor. Carbon is used as the main focus of this study, but other low-Z materials, such as boron, boron carbide, or silicon carbide, could also be investigated.

Pebble rod front-surface recession rates of up to ˜0.5 cm/s were observed, with an average recession rate of 0.2 cm/s at full heat loads. These recession rates are too low for tokamak reactor attached (outer) divertor leg operation, but would be sufficient for a tokamak reactor detached (inner) leg and are expected to be easily sufficient for tritium recovery and physical/chemical sputtering resistance.

Outgassing of volatile species at reactor-tolerable rates less than 1000 Torr-L/s/m² during heating at loads ≈50 MW/m² were demonstrated. However, non-volatile species outgassing (carbon sublimation) remains considerably above 1000 Torr-L/s/m² for heat loads exceeding 15 MW/m².

Pebble ejection velocity is tolerably low (<10 m/s), so ejected pebbles are not expected to reach deep into the core of the divertor plasma and are expected to fall down by gravity, allowing recovery below the divertor plates.

The slurry extrusion friction force was found to be tolerably low (<50 N for a tube length of 1 m).

Drying of the volatile species during baking occurs at a time scale of less than 2.5 min, indicating that the length of the delivery tube (<1 m at desirable extrusion speeds), which is compatible with tokamak reactors.

2D simulations based on the assumption that front-surface recession is caused by matrix cracking due to thermal expansion of carbon spheres have been able to nominally agree with the typically observed recession rate of 0.2 cm/s, suggesting that the basic recession mechanism is at least partially understood.

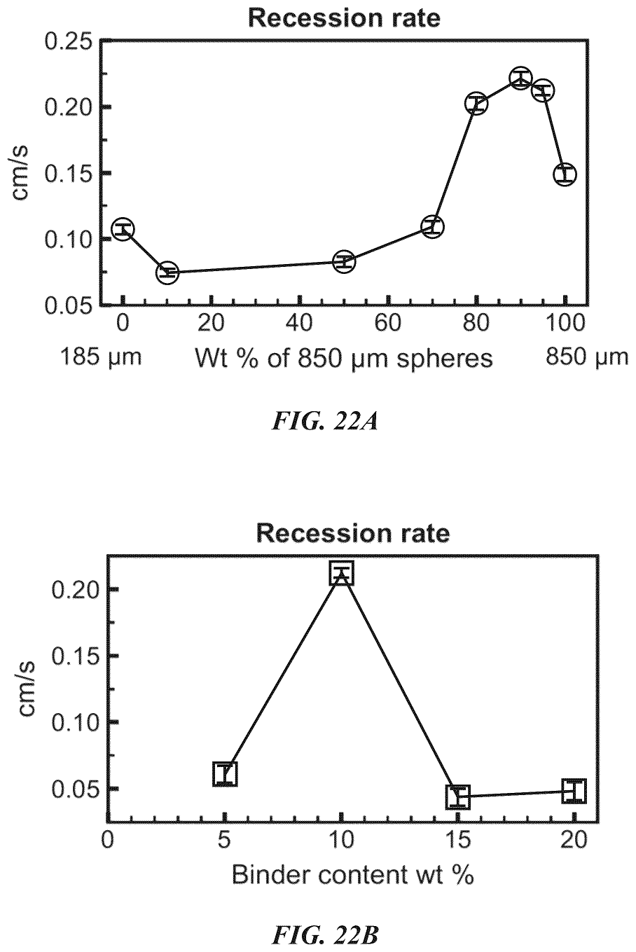

FIGS. 22A-22B show parameter scans to change front-surface recession rate by varying pebble size and varying binder fraction. Specifically, FIG. 22A shows scan of small vs large pebble fraction and FIG. 22B shows scan of binder fraction.

The disclosed technology can be implemented in some embodiments to increase the pebble rod front-surface recession rate, aiming at mitigating carbon sublimation. Only one pebble rod composition is focused on in this example. In addition, the disclosed technology can be implemented in some embodiments to attempt to achieve increased recession rates through changes in pebble radius, pebble composition, and binder composition; as well as through changes in the manufacture and preparation process. Examples of this are shown in FIGS. 22A-22B, which demonstrates changes in recession rate for (FIG. 22A) varying fractions of smaller (0.185 mm diameter) pebbles added to a dominantly larger (0.85 mm diameter) pebble rod mixture and (FIG. 22B) varying fractions of binder (with just the standard 0.85 mm pebbles). In some implementations, simulations may use 3D simulations and extrapolations to neutron-heated reactor environments.

As discussed above, the disclosed technology can be implemented in some embodiments to provide a renewable low-Z wall for fusion reactors with built-in tritium recovery.

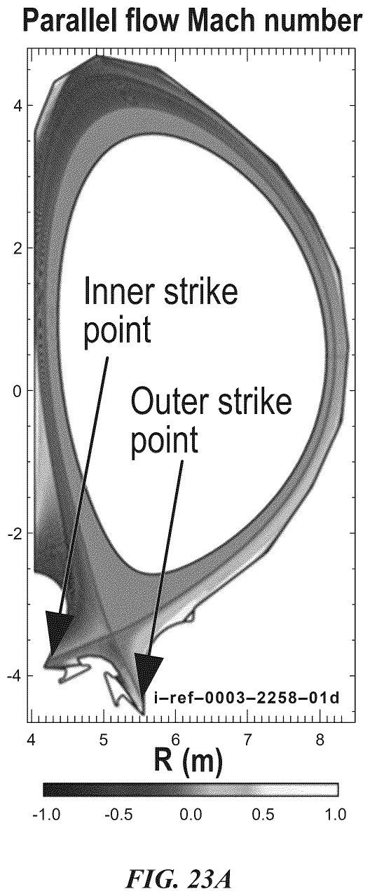

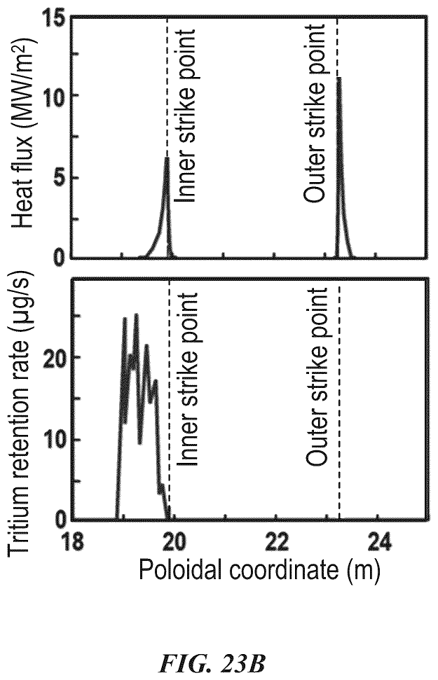

FIGS. 23A-23B show international thermonuclear experimental reactor (ITER) simulations to illustrate that most heat loads and tritium retention will occur in the lower divertor region.

First wall of magnetic fusion reactors will have (1) erosion regions with huge heat loads (up to 40 MW/m² steady-state) and erosion rates (up to 1 cm/week) which will destroy the wall, (2) cold deposition regions with tritium deposition, which robs expensive fuel from reactor.

Fixed solid walls of any material (high or low Z) cannot fully address these issues, and liquid metal walls have problems with vapor pressure, MHD, impurity clogging, and return flow.

As shown in FIG. 1, the disclosed technology can be implemented in some embodiments to extrude pebble rods at erosion and deposition regions. In some reactors implemented based on some embodiments of the disclosed technology, low-Z (e.g., C, B, BC, BN, or SiC) pebble rods may be used.

In some embodiments of the disclosed technology, a method may include the following operations: pebbles are delivered toward first wall mixed into slurry; slurry is baked into conglomerate near first wall and extruded as rods; rods disintegrate into pebbles on being hit by huge plasma heat flux; and pebbles are recovered in trays to extract heat and tritium.

The method based on some embodiments of the disclosed technology can exhibit: good core performance (low radiation); increased tritium pumping; high divertor heat handling without close-in cooling channels; high erosion resistance; good disruption resistance (no melt flow); and no transmutation of divertor plasma-facing components.

First wall brush pattern of extruded rods is shown in FIGS. 2A-2C. Different rod patterns may be used to optimize wall coverage. The disclosed technology can be implemented in some embodiments to maintain an extrusion rate at several mm/s to handle reactor heat loads.

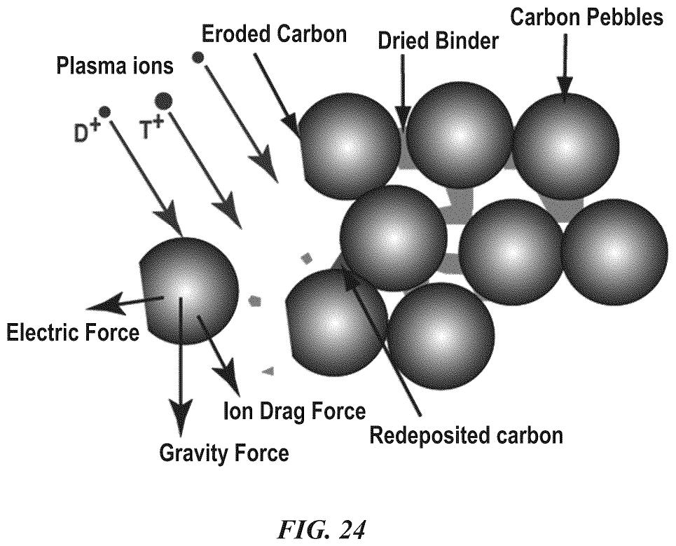

FIG. 24 shows an illustration of forces on pebbles falling into plasma.

The disclosed technology can be implemented in some embodiments to provide pebbles at the millimeter size scale so that gravity dominates forces on pebbles. The disclosed technology can be implemented in some embodiments to use as little binder as possible (to avoid dust flying into plasma). The disclosed technology can be implemented in some embodiments to provide pebbles to heat to about 2000° C. before falling off (to carry away heat, but not release carbon vapor).

As shown in FIG. 3A, a baking stand allows baking up to 1000° C. and backfilling of pebbles with different gases. In some implementations, a breaking stand may be used to study baked rod mechanical strength.

In some implementations, a baking test stand may be used to make samples quickly and study backfilling with different gases.

As shown in FIGS. 4A-4B, an extrusion test stand can be used to study friction force on extruded slurry. The extrusion test stand may be used to: measure slurry friction at range of velocities from 0-2 cm/s; bake slurry while extruding at up to 1000° C.; and measure front-surface outgassing rate of slurry while baking.

As shown in FIGS. 5A and 5D, a heating test stand may create front-surface heat loads up to 50 MW/m² on 1 cm² sample, and may use two steady-state 3 kW fiber lasers.

In some implementations, a heat flux test stand may be used to study slurry response to high front-surface heat loads.

The disclosed technology can be implemented in some embodiments to extrapolate to reactor environment using finite-element modeling (BISON code) including neutrons.

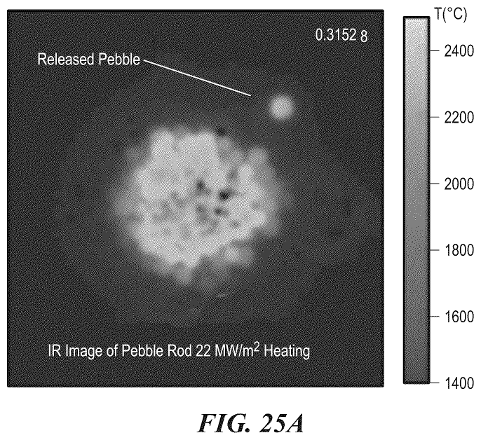

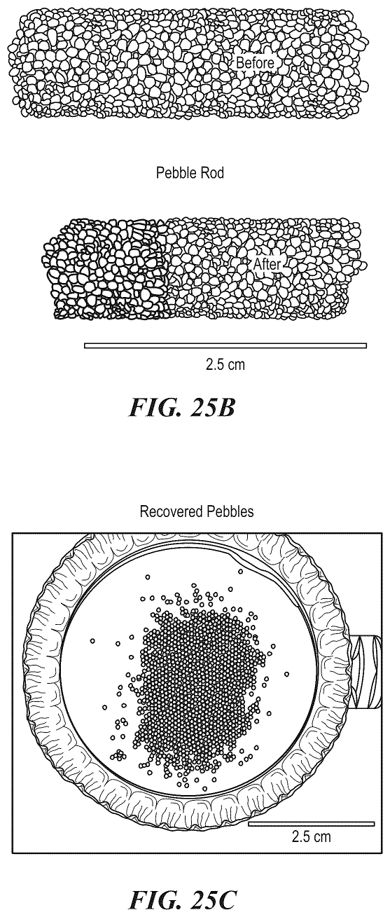

FIGS. 25A-25C show intact pebble recovery. Laser power is delivered to front of samples. Imaging shows that pebbles are released from surface, typically singly, but sometimes in groups of 2-3. Front surface recession at close to desired rates (several mm/s) was observed. Recovery of intact pebbles was demonstrated.

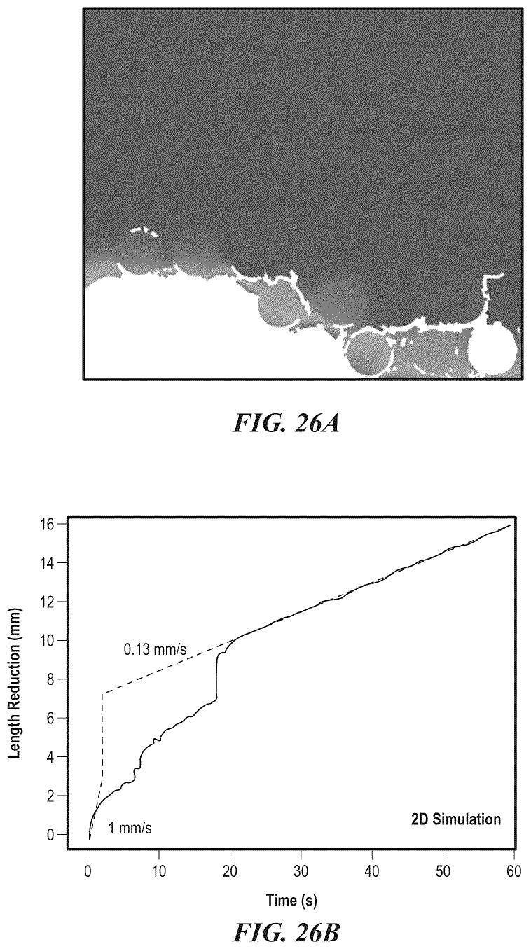

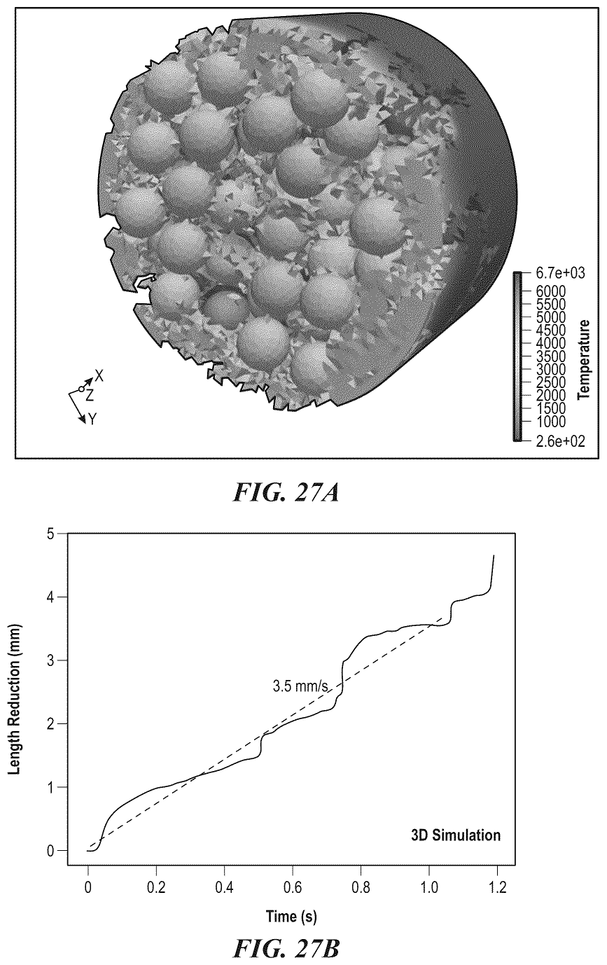

FIGS. 26A-26B show 2D simulation of agglomerate recession under high heat loads, and FIGS. 27A-27B show 3D simulation of agglomerate recession under high heat loads.

MOOSE finite-element simulations capture pebble rod recession. Pebble material properties are known from manufacturer, and inter-pebble matrix properties are determined experimentally. The observed recession rates of several mm/s can match 3D simulations. Thus, breaking process (thermal shock causing matrix cracking) is reasonably understood.

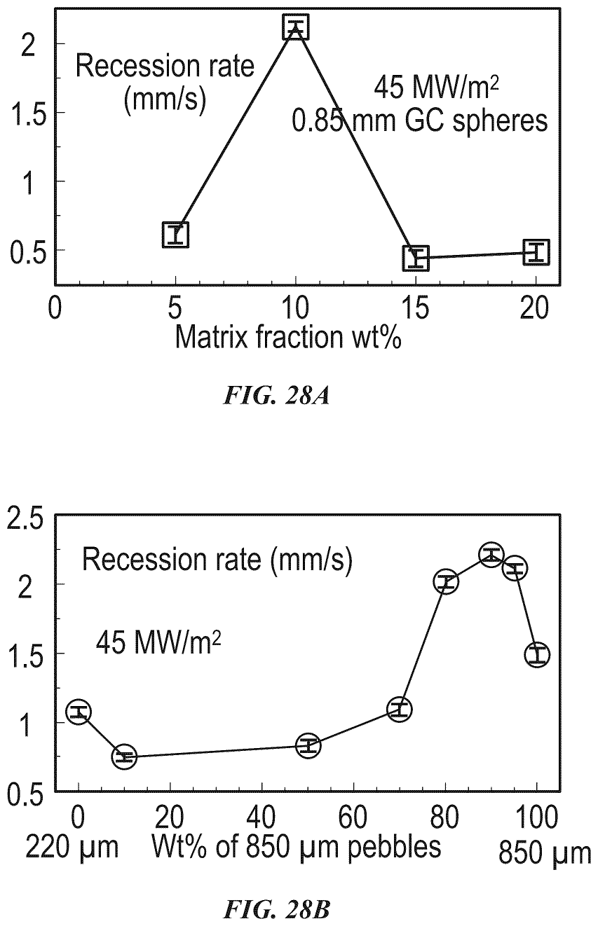

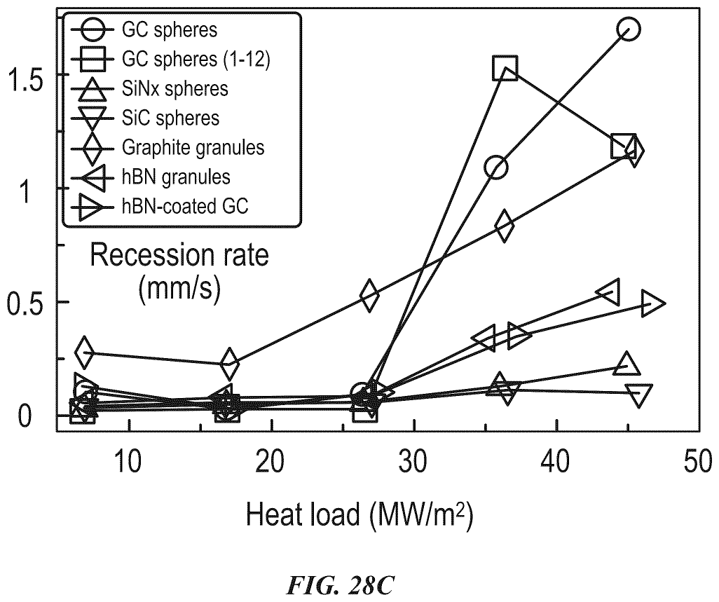

FIGS. 28A-28C show tuneability of pebble recession achieved by tuning binder (matrix) fraction, pebble size, and pebble composition.

In some implementations, there can be quite different requirements for different divertor regions. In some implementations, outer leg strike point region must have fast recession rate to give high heat load handling without going into sublimation. In some implementations, other regions can tolerate lower recession rate, mostly need to prevent tritium deposition. The disclosed technology can be implemented in some embodiments to change pebble recession rate at given heat flux by changing matrix fraction, changing pebble size, or changing pebble material.

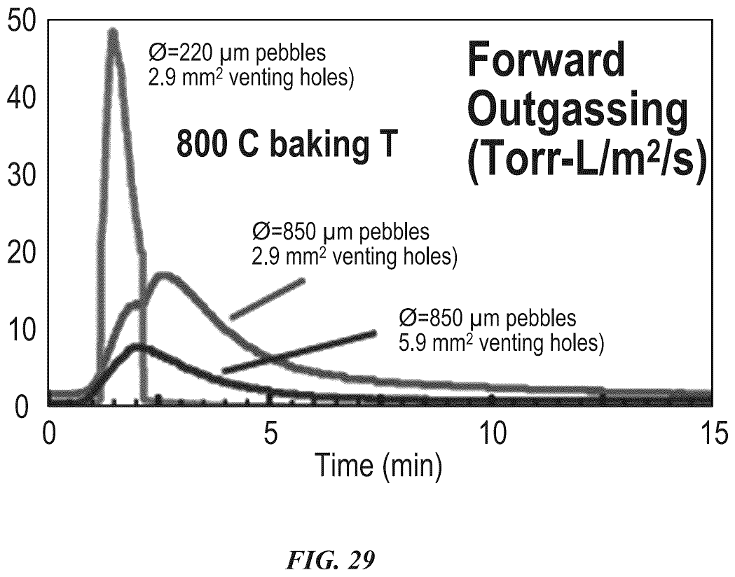

FIG. 29 shows bake-out in an extrusion stand, showing front-surface outgassing during bake-out well below upper limit of 1000 Torr-L/s/m² within desired timescale of 10 min.

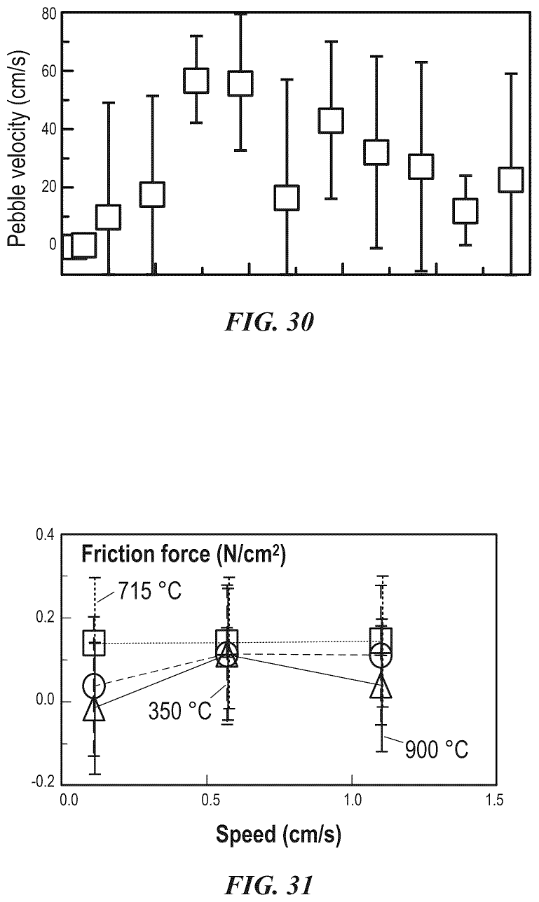

FIG. 30 shows low ejected pebble velocity. The disclosed technology can be implemented in some embodiments to keep ejected pebble velocity low (<10 m/s) for easier pebble recovery. In some implementations, measured velocities are low (<10 m/s).

FIG. 31 shows an example of low extrusion friction force in an extrusion stand.

Friction force during slurry extrusion found to be low (<0.5 lb for 10 cm long sample in stainless steel tube) at desired extrusion velocity ≈0.5 cm/s.

As discussed above, extruded low-Z pebble rods address many of the challenges facing fusion reactor first walls. The disclosed technology can be implemented to provide: reactor relevant heat load handling 40 MW/m² and intact pebble recovery; desired rate of front-surface erosion at up to 0.5 cm/s; friction force during slurry extrusion at 0.5 cm/s is tolerably low; tunability of recession rate by changing pebble rod composition; finite element simulations can match observed recession when going to 3D simulations.

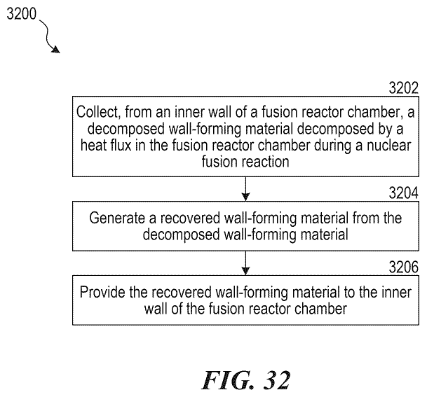

FIG. 32 shows an example method for wall-forming material recovery based on some embodiments of the disclosed technology.

In some implementations, a method 3200 for wall-forming material recovery may include, at 3202, collecting, from an inner wall of a fusion reactor chamber, a decomposed wall-forming material decomposed by a heat flux in the fusion reactor chamber during a nuclear fusion reaction, at 3204, generating a recovered wall-forming material from the decomposed wall-forming material, and, at 3206, providing the recovered wall-forming material to the inner wall of the fusion reactor chamber.

Therefore, various implementations of features of the disclosed technology can be made based on the above disclosure, including the examples listed below.

Example 1. A fusion reactor device, comprising: a fusion reactor chamber including an inner wall that is at least partially made of a wall-forming material to be exposed to a heat flux in the fusion reactor chamber during a nuclear fusion reaction; a material collection system structured to collect, from the inner wall of the fusion reactor, a decomposed wall-forming material decomposed by the heat flux; a material recovery unit coupled to the material collection system to recover the decomposed wall-forming material and to provide a recovered wall-forming material to a wall-forming material container; and an array of extrusion channels coupled between the inner wall and the wall-forming material container to feed the recovered wall-forming material from the wall-forming material container toward the inner wall of the fusion reactor chamber. In some implementations, the material collection system may include a recovery tray discussed above.

Example 2. The device of example 1, wherein the wall-forming material includes pebbles mixed with a binder material.

Example 3. The device of example 2, wherein the binder material is configured to be activated by the heat flux to bond the pebbles together.

Example 4. The device of example 3, wherein the extrusion channels are structured to extrude, into the fusion reactor chamber, pebble rods generated from the pebbles mixed with the binder material.

Example 5. The device of example 4, wherein the material collection system is operable to collect pebbles decomposed from the pebble rods.

Example 6. The device of example 5, wherein the material recovery unit is operable to recover the collected pebbles and tritium soaked up by the pebbles, wherein the tritium is operable to fuel the fusion reactor device.

Example 7. The device of example 1, wherein the material recovery unit includes: a pebble heat extraction unit coupled to the material collection system to decrease a temperature of the decomposed wall-forming material collected by the material collection system; and a pebble reforming and tritium recovery unit coupled to the pebble heat extraction unit to receive the decomposed wall-forming material from the pebble heat extraction unit and generate the recovered wall-forming material while extracting tritium from the decomposed wall-forming material.

Example 8. The device of example 1, wherein the wall-forming material includes a slurry of pebbles mixed with binders.

Example 9. The device of example 8, wherein the wall-forming material container includes a slurry pump configured to feed the slurry of pebbles mixed with binders toward the inner wall of the fusion reactor chamber.

Example 10. The device of any of examples 2-9, wherein the pebbles include at least one of graphite, boron, glassy carbon, boron nitride, beryllium, or tungsten.

Example 11. The device of example 1, wherein each of the extrusion channels includes a first end exposed to an inner space of the fusion reactor chamber and configured to carry the recovered wall-forming material in a direction toward the inner space of the fusion reactor chamber.

Example 12. The device of example 11, wherein the first ends of the extrusion channels are arranged in a first pattern.

Example 13. The device of example 12, wherein the first pattern includes a

hexagonal pattern.

Example 14. A fusion reactor chamber, comprising: an inner wall structured to be exposed to a heat flux in the fusion reactor chamber during a nuclear fusion reaction; and an array of extrusion channels, each extrusion channel includes a first end exposed to an inner space of the fusion reactor chamber and configured to carry a wall-forming material in a direction toward the inner space of the fusion reactor chamber.

Example 15. The fusion reactor chamber of example 14, wherein the first ends of the extrusion channels form a first pattern.

Example 16. The fusion reactor chamber of example 15, wherein the first pattern includes a hexagonal pattern.

Example 17. The fusion reactor chamber of example 14, wherein the wall-forming material includes pebbles mixed with a binder material.

Example 18. The fusion reactor chamber of example 17, wherein the extrusion channels are structured to extrude, into the inner space of the fusion reactor chamber, pebble rods generated from the pebbles and the binder material.

Example 19. The fusion reactor chamber of any of examples 17-18, wherein the pebbles include at least one of graphite, boron, glassy carbon, boron nitride, beryllium, or tungsten.

Example 20. A method for wall-forming material recovery, comprising: collecting, from an inner wall of a fusion reactor chamber, a decomposed wall-forming material decomposed by a heat flux in the fusion reactor chamber during a nuclear fusion reaction; generating a recovered wall-forming material from the decomposed wall-forming material; and providing the recovered wall-forming material to the inner wall of the fusion reactor chamber.

Example 21. The method of example 20, wherein generating the recovered wall-forming material from the decomposed wall-forming material includes: decreasing a temperature of the decomposed wall-forming material; and generating the recovered wall-forming material while extracting tritium from the decomposed wall-forming material.

Example 22. The method of example 20, wherein collecting the decomposed wall-forming material includes collecting the decomposed wall-forming material from a material collection system disposed in the fusion reactor chamber.

Example 23. The method of example 20, wherein providing the recovered wall-forming material to the inner wall of the fusion reactor chamber includes using a slurry pump configured to feed the recovered wall-forming material to the inner wall of the fusion reactor chamber.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A fusion reactor device, comprising:
a fusion reactor chamber including an inner wall that is at least partially made of a wall-forming material to be exposed to a heat flux in the fusion reactor chamber during a nuclear fusion reaction;
a material collection system structured to collect, from the inner wall of the fusion reactor, a decomposed wall-forming material decomposed by the heat flux;
a material recovery unit coupled to the material collection system to recover the decomposed wall-forming material and to provide a recovered wall-forming material to a wall-forming material container; and
an array of extrusion channels coupled between the inner wall and the wall-forming material container to feed the recovered wall-forming material from the wall-forming material container toward the inner wall of the fusion reactor chamber.

2. The device of claim 1, wherein the wall-forming material includes pebbles mixed with a binder material.

3. The device of claim 2, wherein the binder material is configured to be activated by the heat flux to bond the pebbles together.

4. The device of claim 3, wherein the extrusion channels are structured to extrude, into the fusion reactor chamber, pebble rods generated from the pebbles mixed with the binder material.

5. The device of claim 4, wherein the material collection system is operable to collect pebbles decomposed from the pebble rods.

6. The device of claim 5, wherein the material recovery unit is operable to recover the collected pebbles and tritium soaked up by the pebbles, wherein the tritium is operable to fuel the fusion reactor device.

7. The device of claim 1, wherein the material recovery unit includes: a pebble heat extraction unit coupled to the material collection system to decrease a temperature of the decomposed wall-forming material collected by the material collection system; and a pebble reforming and tritium recovery unit coupled to the pebble heat extraction unit to receive the decomposed wall-forming material from the pebble heat extraction unit and generate the recovered wall-forming material while extracting tritium from the decomposed wall-forming material.

8. The device of claim 1, wherein the wall-forming material includes a slurry of pebbles mixed with binders.

9. The device of claim 8, wherein the wall-forming material container includes a slurry pump configured to feed the slurry of pebbles mixed with binders toward the inner wall of the fusion reactor chamber.

10. The device of claim 2, wherein the pebbles include at least one of graphite, boron, glassy carbon, boron nitride, beryllium, or tungsten.

11. The device of claim 1, wherein each of the extrusion channels includes a first end exposed to an inner space of the fusion reactor chamber and configured to carry the recovered wall-forming material in a direction toward the inner space of the fusion reactor chamber.

12. The device of claim 11, wherein the first ends of the extrusion channels are arranged in a first pattern.

13. The device of claim 12, wherein the first pattern includes a hexagonal pattern.

14. A fusion reactor chamber, comprising:
an inner wall structured to be exposed to a heat flux in the fusion reactor chamber during a nuclear fusion reaction; and
an array of extrusion channels, each extrusion channel includes a first end exposed to an inner space of the fusion reactor chamber and configured to carry a wall-forming material in a direction toward the inner space of the fusion reactor chamber.

15. The fusion reactor chamber of claim 14, wherein the first ends of the extrusion channels form a first pattern.

16. The fusion reactor chamber of claim 15, wherein the first pattern includes a hexagonal pattern.

17. The fusion reactor chamber of claim 14, wherein the wall-forming material includes pebbles mixed with a binder material.

18. The fusion reactor chamber of claim 17, wherein the extrusion channels are structured to extrude, into the inner space of the fusion reactor chamber, pebble rods generated from the pebbles and the binder material.

19. The fusion reactor chamber of claim 17, wherein the pebbles include at least one of graphite, boron, glassy carbon, boron nitride, beryllium, or tungsten.

20. A method for wall-forming material recovery, comprising:
collecting, from an inner wall of a fusion reactor chamber, a decomposed wall-forming material decomposed by a heat flux in the fusion reactor chamber during a nuclear fusion reaction;
generating a recovered wall-forming material from the decomposed wall-forming material; and
providing the recovered wall-forming material to the inner wall of the fusion reactor chamber.

21. The method of claim 20, wherein generating the recovered wall-forming material from the decomposed wall-forming material includes: decreasing a temperature of the decomposed wall-forming material; and generating the recovered wall-forming material while extracting tritium from the decomposed wall-forming material.

22. The method of claim 20, wherein collecting the decomposed wall-forming material includes collecting the decomposed wall-forming material from a material collection system disposed in the fusion reactor chamber.

23. The method of claim 20, wherein providing the recovered wall-forming material to the inner wall of the fusion reactor chamber includes using a slurry pump configured to feed the recovered wall-forming material to the inner wall of the fusion reactor chamber.
